(19) United States
(12) Patent Application Publication
(10) Pub. No.: US 2026/0167576 A1
(43) Pub. Date: Jun. 18, 2026

(54) ACTIVATOR ADMIXTURE FOR CEMENT REDUCTION IN CONCRETE COMPOSITIONS

(71) Applicant: NEOCRETE LIMITED, Auckland (NZ)

(72) Inventors: Oleg BAZOEV, Auckland (NZ); Zarina BAZOEVA, Auckland (NZ)

(21) Appl. No.: 19/151,282

(22) PCT Filed: Aug. 21, 2024
(86) PCT No.: PCT/NZ2024/050095

§ 371 Date: Aug. 4, 2025

(30) Foreign Application Priority Data
Aug. 22, 2023 (AU) 2023902683

(51) Int. Cl. C04B 40/00; C04B 22/06; C04B 28/04; C04B 103/32; C04B 111/00

(52) U.S. Cl. CPC C04B 40/0042; C04B 22/06; C04B 28/04; C04B 40/0007; C04B 2103/32; C04B 2111/00215

(57) ABSTRACT

The present disclosure relates to activator admixtures for preparing concrete. In particular, although not exclusively, the invention relates to activator admixtures comprising at least two pozzolan portions with distinct chemical compositions and/or particle size distributions. Activator admixtures for concrete, and methods of production and use are provided which enable the user to reduce cement content and therefore reduce embodied carbon of concrete compositions while maintaining or increasing strength and workability. The activator admixtures of the invention have broad application to concrete compositions used in buildings, roading, footpaths, structures exposed to harsh environments, marine structures, bridges, dams, and standard or high-performance concrete for precast elements.

### TECHNICAL FIELD

The present disclosure relates to activator admixtures for preparing concrete. These activators are formulated for use in minimal dosages within a concrete mix, yet they elicit substantial improvements in the resulting concrete's properties. In particular embodiments, the activator admixture has an electrostatic charge and comprises at least two pozzolan portions each with distinct chemical compositions and particle size distributions.

### BACKGROUND

Cement is a widely used construction material, which is produced by grinding clinker, gypsum, and other mineral additives. While cement production is a vital component of the construction industry, it comes with significant environmental challenges, in particular related to carbon emissions. Cement production is a major contributor to global CO2 emissions. The primary source of CO2 emissions in cement production is the chemical reaction involved in converting limestone (calcium carbonate) into lime (calcium oxide) during the process known as calcination. This process releases CO2 as a byproduct, accounting for around 50% of the total emissions associated with cement production. As well as direct emissions, cement manufacturing also requires substantial energy inputs. The processes involved demand a significant amount of energy, primarily derived from fossil fuels. For example, quarrying raw materials, crushing, grinding, and heating them to high temperatures.

There is a desire to replace at least a portion of the cement used to make concrete with other materials which maintain the concrete properties but have a lower carbon footprint. One common material used in cement production is pozzolan, which can replace a portion of cement while also enhancing the strength and durability of concrete. Pozzolans are naturally occurring or synthetic materials that react with calcium hydroxide and water to form a cementitious material.

Pozzolans also have the ability to react with lime and water. When pozzolans react with lime in the presence of water, hydroxyl ions are released, causing an increase in the pH value. At that point, pozzolanic reactions occur where silicon and aluminium are combined with the available calcium, generating the cementitious compounds calcium silicate hydrate (CSH) and calcium aluminate hydrate (CAH).

These compounds improve the mechanical properties of the mixture due to the continuous development of pozzolanic reaction products:

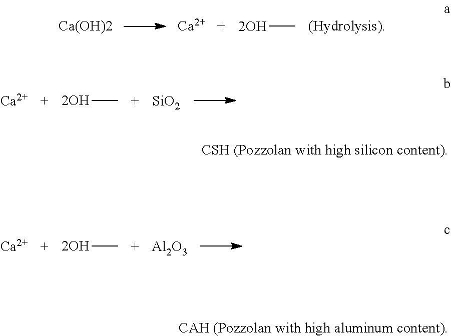

Natural pozzolans are pozzolanic materials that occur naturally in the earth's crust. When natural pozzolans are added to cement, they react with the calcium hydroxide released during the hydration process to form calcium silicate hydrate (CSH) gel, which acts as a binder in concrete. This reaction produces a denser and more durable concrete with improved compressive strength, reduced permeability, and enhanced chemical resistance. Other benefits of using natural pozzolans are realised in terms of performance, sustainability, and cost-effectiveness.

A further advantage of using natural pozzolans in concrete is their environmental sustainability. They are locally available, non-toxic, and require less energy to produce than artificial pozzolans such as fly ash and slag. In terms of specific applications, natural pozzolans can be used in concrete for structures exposed to harsh environments, such as marine structures, bridges, and dams. They can also be used to produce high-performance concrete for precast elements, and in the production of low-cost housing and pavements. An important factor in the performance of pozzolanic materials in concrete is the fact that the pozzolanic reaction is slower than cement-hydration reaction. This means the strength development of pozzolanic concrete is significantly delayed, limiting the application of the concrete in construction.

Synthetic pozzolans, on the other hand, are artificially produced materials that exhibit pozzolanic properties similar to natural pozzolans. These include materials such as fly ash, silica fume, and slag. When incorporated into concrete, synthetic pozzolans also undergo pozzolanic reactions, resulting in the formation of calcium silicate hydrate (CSH) gel, which enhances the concrete's strength, durability, and chemical resistance.

In addition to improving the mechanical properties of concrete, synthetic pozzolans contribute to sustainability efforts by recycling industrial by-products. For example, fly ash is a by-product of coal combustion in power plants, and silica fume is a by-product of silicon metal and ferrosilicon alloy production. By incorporating these materials into concrete, industries can reduce waste and lower the carbon footprint associated with cement production. Moreover, synthetic pozzolans can be engineered to have consistent quality and performance characteristics, making them suitable for a wide range of concrete applications, from general construction to specialised infrastructure projects.

A key benefit of synthetic pozzolans is their availability and consistency, which can be advantageous in regions where natural pozzolans are scarce or of variable quality. Additionally, synthetic pozzolans can be tailored to specific performance requirements, allowing for the production of concrete with enhanced properties, such as higher resistance to sulphate attack, improved workability, and reduced heat of hydration. These characteristics make synthetic pozzolans an attractive option for use in large-scale construction projects, such as high-rise buildings, industrial facilities, and infrastructure that demands high-performance materials.

Despite their advantages, the use of synthetic pozzolans in concrete also presents certain challenges. The variability in the chemical composition of synthetic pozzolans, especially fly ash, can affect the performance of the resulting concrete. Additionally, the energy-intensive processes required to produce some synthetic pozzolans, such as slag, can offset some of the environmental benefits. Therefore, careful selection and testing of synthetic pozzolans are essential to ensure that they meet the specific needs of a given concrete application.

Addition of pozzolanic material to concrete is generally viewed as negatively affecting its workability and fresh concrete properties, making it harder to produce, deliver and place on construction sites which creates challenges for its use.

In light of the above, there is a need for an activator admixture for pozzolanic concrete, to address its challenges and enable its wider adoption across the industry and thus optimise the performance of concrete while minimising its environmental impact. The present invention at least partially addresses this need by providing activators and methods of concrete production using pozzolans that accelerate their chemical reactions and enable rapid strength development. These activator- and pozzolan-containing concretes exhibit properties similar to pure cement-based concrete while at the same time increasing early strength, workability and decreasing embodied carbon emissions.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the invention to provide activators for concrete to enable enhanced strength, workability and/or durability, concrete compositions comprising the activators, and related methods of use and production, that overcome or ameliorate at least one of the disadvantages of the prior art. Alternatively, it is an object of the invention to provide the public with a useful choice.

### SUMMARY OF THE INVENTION

In one aspect, the invention provides an activator admixture for producing concrete, the activator comprising a pozzolan component, wherein the pozzolan component comprises a first pozzolan portion and at least a second pozzolan portion, wherein the first and second pozzolan portions comprise different median particle sizes and/or chemical compositions.

In some examples, the activator further comprises a plasticiser component, preferably a powdered plasticiser component.

In some examples, the activator admixture comprises an electrostatic charge. The electrostatic charge may have been applied to the activator by any suitable method. In some examples, the electrostatic charge has been applied by way of external electrical or electrostatic fields generated by electrodes, electrostatic spraying techniques, triboelectric charging in a fluidised bed, corona discharge methods, electrostatic fluidisation, and mechanical mixing-induced friction.

In a further aspect, the invention provides an activator admixture for producing concrete, the activator comprising a pozzolan component and a plasticiser component, wherein the pozzolan component comprises a chemical composition comprising 20-80% w/w silicon dioxide, and 5-40% w/w aluminium oxide.

In a further aspect, the invention provides an activator admixture for producing concrete, the activator comprising a pozzolan component and a plasticiser component, wherein the pozzolan component comprises a chemical composition comprising 40-80% w/w silicon dioxide, and 10-40% w/w aluminium oxide.

In some examples, the pozzolan component comprises a first pozzolan portion with a first chemical composition and a second pozzolan portion with a second chemical composition.

In some examples, the activator comprises a Dv50 of less than 40 μm. In some examples, the activator comprises a Dv50 of less than 50 μm. In some examples, the Dv50 comprises 10-50 μm.

In some examples, the activator comprises a powdered activator admixture.

In a further aspect, there is provided an activator admixture for use as an admixture for concrete comprising:
a) a pozzolan component comprising at least two pozzolans comprising distinct particle sizes and/or chemical compositions; and
b) a powdered plasticiser.

In some examples the first pozzolan portion exhibits a volume density peak of between 0.3 and 1.5% for particles at between 0.5 μm and 1.5 μm and the second pozzolan portion exhibits a volume density peak of greater than 3% between 10 μm and 80 μm. In some examples, a volume density ratio of the first pozzolan portion peak to the second pozzolan portion peak comprises 1:3 to 1:6.

In some examples, the plasticiser comprises a particle size from 50-500 μm.

In some examples the pozzolan component and plasticiser have been mixed for over 5 minutes.

In some examples, the activator comprises a plasticiser at a percentage (w/w) of from about 8% to about 40%.

In some examples, the activator comprises a plasticiser at a percentage (w/w) of from about 10% to about 25%.

The plasticiser may comprise at least one of:
a) a polycarboxylate plasticiser;
b) a naphthalene-based plasticiser;
c) a lignosulphonate plasticiser;
d) a dry powder plasticiser; and
e) a dry powder polycarboxylate plasticiser.

In other examples, the plasticiser bay be applied at a higher proportion, for example from 10-35% when a significant increase in workability is needed, such as in highly reinforced sections where the concrete needs to flow easily around the reinforcement, or in complex formwork, or where a significant reduction in water-cement ratio is needed to achieve high strength or enhanced durability.

The activator may comprise from about 9:1 pozzolan: plasticiser to about 3:1 pozzolan: plasticiser. In another example, the activator comprises a ratio of pozzolan component to plasticiser at a ratio of from 11:1 to 1.5:1 pozzolan: plasticiser.

In some examples, the activator comprises a ratio of pozzolan component to plasticiser at a ratio of from 9:1 pozzolan: plasticiser to about 3:1 pozzolan: plasticiser.

In one example the plasticiser present in the activator has a Dv50 of from about 50-500 μm. In another example, the plasticiser present in the activator has a Dv50 of from about 100-200 μm.

In one example the plasticiser is added to the other activator components as a powdered plasticiser.

In examples of any of the aspects described herein, the activator admixture comprises a particle size distribution defined by:
15-55% of particles are less than 15 μm;
50-80% of particles are less than 40 μm; and
70-100% of particles are less than 90 μm.

In examples of any of the aspects described herein, the activator admixture comprises a particle size distribution defined by:
30-40% of particles are less than 15 μm;
50-65% of particles are less than 40 μm; and.
75-90% of particles are less than 90 μm.

In some examples, the specific surface area (SSA) of the activator admixture comprises between 350-1000 m²/kg.

In some examples, the Dv50 of the activator admixture comprises 10-40 μm.

In a further aspect, the invention provides a method of producing an activator composition comprising the steps of:
a. obtaining a first pozzolan portion with a first chemical composition and a second pozzolan portion with a second chemical composition;
b. combining the first pozzolan portion with the second pozzolan portion to form a pozzolan component;
c. mixing the pozzolan component with a plasticiser to produce an activator composition,
   wherein the pozzolan component comprises a chemical composition comprising 20-80% w/w silicon dioxide, and 5-40% aluminium oxide.

In one example, the pozzolan component comprises a chemical composition comprising 40-80% w/w silicon dioxide, and 10-40% aluminium oxide.

In a further aspect, the invention provides a method of producing an activator for use as an admixture for concrete comprising the steps of:
a. obtaining a first pozzolan portion with a first chemical composition and a first particle size Dv50,
b. obtaining a second pozzolan portion with a second chemical composition and a second particle size Dv50;
c. combining the first pozzolan portion with the second pozzolan portion to form a pozzolan component;
d. mixing the pozzolan component with a plasticiser to produce an activator composition.

In one example, the method of producing an activator further comprises the application of an electrical or electrostatic charge according to methods described herein.

In one example the plasticiser comprises a powdered plasticiser.

In one example, the mixing step is carried out for a period of at least five minutes.

In one example, the activator comprises an intermediate particle size distribution and a coarse particle size distribution. In one example the intermediate median particle size is in a range of 0.5-1.5 μm and the coarse median particle size is in a range between 10-80 μm.

In one example, the plasticiser is present at 8-40% w/w of activator.

In one example, the activator comprises a Dv50 of less than 40 μm. In some examples, the activator comprises a Dv50 of between 10 and 50.

In a further aspect, the invention provides a method of producing a concrete composition comprising combining:
a. an activator of any of the previous aspects or examples;
b. aggregate;
c. cement; and
d. water.

In some examples, the method of producing a concrete composition comprises a powdered activator comprising 20-80% w/w silicon dioxide, 5-40% w/w aluminium oxide, a particle size distribution defined by:
a. 15-55% of particles are less than 15 μm;
b. 50-80% of particles are less than 40 μm; and
c. 70-100% of particles are less than 90 μm;
   wherein the concrete composition develops a compressive strength of at least 50 MPa at 28 days, and wherein the composition comprises at least 25% by weight of natural or synthetic pozzolan SCM as a substitute for cement.

In some examples, the method of producing a concrete composition comprising a powdered activator described herein comprising 20-80% w/w silicon dioxide, 5-40% w/w aluminium oxide, a particle size distribution defined by:
a. 15-55% of particles are less than 15 μm;
b. 50-80% of particles are less than 40 μm; and
c. 70-100% of particles are less than 90 μm;
   wherein the concrete composition develops a compressive strength of at least 25 MPa at 28 days, and wherein the composition comprises at least 10% by weight of natural or synthetic pozzolan SCM as a substitute for cement.

In some examples, the concrete composition comprises activator admixture at between 1-4% of by weight of cement

In a further aspect, the invention provides a concrete composition comprising:
a. an activator as described in any of the previous aspects or examples,
b. cementitious material, and
c. aggregate.

In some examples the concrete composition further comprises water.

In a further aspect, the invention provides a method of reducing the overall cementitious material in a concrete composition by up to about 30%, while maintaining or increasing the strength of the concrete, and reducing the embodied carbon of the concrete. In some examples, the reduction in cementitious material is up to about 10%, up to about 20%, up to about 40% or up to about 50%.

In a further aspect, the invention provides a method of reducing the overall cementitious material in a concrete composition by amounts described above, for example up to about 50%, while maintaining or increasing the strength of the concrete, and reducing the embodied carbon of the concrete.

In a further aspect, the invention provides a construction material comprising the activator of any of the previous aspects or examples.

Those of skill in the art will appreciate that the examples, features, variations and embodiments described in relation to any of the aspects herein are intended to be read in combination with the features of any other aspect or example provided herein, regardless of whether such examples, features, variations and embodiments are specifically appended to said aspects or examples.

Aspects of the invention may also be said broadly to consist in the examples, parts, elements and features referred to or indicated in this specification, individually or collectively, in any or all combinations of two or more of said parts, elements or features, and where specific integers are mentioned herein that have known equivalents in the art to which the invention relates, such known equivalents are deemed to be incorporated herein as if individually set forth.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

Embodiments will now be described by way of example only and with reference to the figures:

FIG. 1.a.i—Comparison of strength over time for activator versus control concrete.

FIG. 1.a.ii—Particle size and volume density of particles for activator gamma.

FIG. 1.a.iii—Particle size and volume density of particles for activator omicron.

FIG. 1.b.i—Slump loss of concrete over time for control and activator-containing concrete.

FIG. 1.b.ii—Comparison of strength over time for activator versus control concrete showing that the activators produced concrete with higher compressive strength at all time points. Data for day 28 still to come.

FIG. 1.b.iii—Particle size and volume density of particles for activator Tau.

FIG. 1.b.iv—Particle size and volume density of particles for activator Omega2.

FIG. 1.c.i—Slump loss of concrete over time showing that workability of control 2 and activator retained workability to a similar extent.

FIG. 1.c.ii—Comparison of strength over time for 25 MPa concrete, 40 MPa concrete, and activator-containing concrete using 25 MPa concrete's cement volume with strength at 1, 3, 7 and 28 days post-pour.

FIG. 1.c.iii—Particle size and volume density of particles for activator Pi.

FIG. 2.a.i—Slump loss of concrete over time showing good workability for all activator-containing concrete mixtures.

FIG. 2.a.ii—Comparison of strength over time for activator versus control concrete showing that activator-containing concrete at all cement-reduction levels had compressive strength substantially equal to or greater than control at 1, 3, 7 and 28 days post-pour.

FIG. 2.a.iii—Particle size and volume density of particles for activator Pi.

FIG. 2.a.iv—Particle size and volume density of particles for activator Tau.

FIG. 2.b.i—Slump loss of activator-containing concrete over time showing significant improvement in workability vs. both controls.

FIG. 2.b.ii—Comparison of strength over time for activator versus control concrete showing that activator-containing concrete with 50% less cement produced compressive strength greater than controls 1 and 2 at all tested ages-1, 3, 7 and 28 days post-pour.

FIG. 2.b.iii—Particle size and volume density of particles for activator Tau.

FIG. 3—Comparison of strength over time for KNP activated natural pozzolans vs control and Activator activated pozzolans vs. control, both at 20% cement replacement levels.

FIG. 4—Particle size and volume density of particles for activator Pi.

FIGS. 5A-5C show volume density of particle size classes of activators of the invention in example 5.

FIG. 5D shows compressive strength over time for mortar mixes from example 5.

FIG. 6A shows volume density of particle size classes of an activator of the invention according to example 6.

FIG. 6B shows compressive strength over time for mortar mixes of example 6.

FIG. 7 shows compressive strength over time for mortar mixes of example 7.

FIG. 8 shows compressive strength over time for mortar mixes of example 8.

FIGS. 9A and 9B show exemplary concrete compositions prepared using 9A ordinary Portland cement and 9B activator admixtures of the invention.

FIG. 10 shows compressive strength over time for activators of the invention.

### DETAILED DESCRIPTION OF THE INVENTION

Unless the context clearly indicates otherwise, terms used herein are defined as follows:

“Comprising” means “consisting at least in part of”. When interpreting each statement in this specification that includes the term “comprising”, features other than that or those prefaced by the term may also be present. Related terms such as “comprise”, include”, “including” and “comprises” are to be interpreted in the same manner.

“A” or “an” does not exclude a plurality.

“About” as used herein means a reasonable amount of deviation of the modified term such that the end result is not significantly changed. For example, when applied to a value, the term should be construed as including a deviation of +/−5% of the value.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a dimensional range, a time range, or a composition range, all intermediate ranges and subranges, as well as all individual values included in the ranges given are intended to be included in the disclosure.

“And/or” means additionally or alternatively. Moreover, any use of a term in the singular also encompasses plural forms.

“Particle(s)” refers to particles having a well-defined physical shape as well as those with irregular geometries, including any particles having the physical shape of platelets, shavings, fibers, flakes, ribbons, rods, strips, spheroids, toroids, pellets, tablets, or any other physical shape.

“Cement” includes Portland cement and similar materials that contain one or more of the four clinker materials: C3S (tricalcium silicate), C2S (dicalcium silicate), C3A (tricalcium aluminate), and C4AF (tetracalcium aluminoferrite).

“Concrete activator”, “activator”, or “activator admixture” means a mixture of components for adding to concrete mixtures which modifies the reaction speed or curing process when the activator is added to a concrete mix.

“Natural pozzolan” means a non-calcined natural silified shale mineral that is a Class N Pozzolan is under the chemical and physical requirements of ASTM C-618.

“Binder” means the cementitious materials and any admixture or activator components for use in the preparation of a concrete composition. In some examples, the binder comprises activator plus at least one of Portland cement and Supplementary cementitious materials (SCMs).

“Mortar” designates a mixture of cementitious materials, fillers, sands, water and optionally additives or activator.

“Admixture” means a chemical substance added to a binder, concrete or mortar mix, in minor proportions compared to the primary components, with the purpose of modifying and enhancing specific properties of the final material (e.g. concrete or mortar). These properties include, but are not limited to, workability, setting time, strength, durability, and resistance to environmental factors. Admixtures may be chemical and/or mineral in nature and are employed to achieve characteristics in the concrete that cannot be attained by the primary components alone (cement, water, and aggregates). Activators of the invention are admixtures and references to activator is intended to be read as a reference to an activator admixture.

Concrete admixtures are mixtures that are added to the concrete mixture to enhance its properties and improve its performance. They can be in dry or liquid form. They are typically prepared and sold independently of the concrete and are tailored for different concrete applications. There are many different types of admixtures available, each with its own specific function. Generally, concrete admixtures comprise the following components:

Plasticisers: also known as water reducers, or superplasticisers, reduce the amount of water required to achieve the desired workability of the concrete mixture. They are typically made from sulfonated melamine, lignosulfonates, sulfonated naphthalene, or polycarboxylate-based polymers.

Retarders: Retarders slow down the setting time of concrete, allowing more time for placement, finishing, and transportation. Commonly used retarders include lignosulfonates, carbohydrates, and citric acid. Retarders and natural pozzolans can also work synergistically in concrete, particularly when it comes to controlling the setting time of the mixture. When used together, retarders and natural pozzolans can help to provide greater control over the setting time of the concrete, particularly in situations where a longer setting time is desirable. For example, in hot weather, the addition of a retarder can help to slow down the rate of hydration and prevent the mixture from setting too quickly. Similarly, in situations where longer transport times are required, the use of a combination of retarders and natural pozzolans can help to ensure that the concrete remains workable and does not set before it can be properly placed.

Accelerators: Accelerators are admixture components that speed up the setting and hardening of concrete, allowing it to gain strength more quickly. Calcium chloride is a commonly used accelerator, but other types of accelerators, such as triethanolamine or sodium thiocyanate, can also be used.

Air-Entraining Agents: Air-entraining agents are admixture components that create microscopic bubbles in concrete, which help to improve its durability and workability. They are typically made from natural or synthetic surfactants.

Corrosion Inhibitors: Corrosion inhibitors are admixture components that are added to concrete to prevent the corrosion of reinforcing steel. They work by forming a protective layer around the steel, which prevents the penetration of corrosive agents.

Colorants: Added to concrete to give it a specific colour or hue. They are typically made from pigments or dyes.

The activators of the invention described herein are admixtures in that they are added as a minor component of a mixture which also comprises cementitious materials to achieve a binder, mortar and/or concrete with modified properties. In one example, activator admixtures of the present invention are added to a concrete, mortar or binder composition at only 1-4% w/w of cementitious material. Activators include some or all of the above-referenced components and are preferably prepared in dry powder form. One function of the activator is to activate cementitious materials such as natural or synthetic pozzolans so that they act as a binder rather than simply being a filler. The activators of the invention are believed to speed up the pozzolanic reaction by way of their surface reactivity which is in some examples provided by generation of electrostatic forces meaning that the strength gain of the resulting concrete (containing the activator plus additional cementitious materials such as natural or synthetic pozzolans) is achieved at a similar or higher rate to cement-based concrete without activator.

Concrete comprising activators of the invention plus natural or synthetic pozzolans have a higher rate of strength development and ultimate strength than concrete comprising only natural or synthetic pozzolans. Example 2b and other examples demonstrate this effect. Activators of the invention also have the surprising effect of activating cement and optionally fillers to be more effective binders as shown by the examples.

Natural pozzolans are siliceous or silico-aluminous materials and are composed of various chemical compounds, including silica, alumina, iron oxide, calcium oxide, magnesium oxide, and potassium oxide. These compounds are responsible for the pozzolanic activity of natural pozzolans and their ability to contribute to the strength and durability of concrete. Where concrete comprises natural pozzolans, their properties play a critical role in the performance of the concrete.

The reactivity of natural pozzolans is related to their content of reactive silica and alumina, as well as the amorphousness of their structure. These properties determine the pozzolanic activity, which is the ability of the natural pozzolan to react with calcium hydroxide in the presence of water to form calcium silicate hydrate (CSH) and other cementitious compounds that contribute to the strength and durability of the concrete.

Silicon dioxide (silica) is the primary component of natural pozzolans, accounting for up to 90% of their composition. It is a key component in the formation of the pozzolanic reaction, and it contributes to the development of the strength and durability of the resulting concrete. The amount of reactive silica in the natural pozzolan is an important factor in its pozzolanic activity. Aluminium oxide (alumina) is another important component of natural pozzolans, and it plays a key role in the formation of the pozzolanic reaction. Alumina reacts with calcium hydroxide to form calcium aluminate hydrates, which contribute to the strength and durability of the concrete.

The percentage of each of the chemical compounds found in natural pozzolans can vary depending on the type of natural pozzolan and its geological origin. Controlling the chemical composition of natural pozzolans before using them in concrete mixtures is important to ensure that they result in the desired concrete properties once mixed. They must also be compatible with the other ingredients in the mix and not create compounds detrimental to concrete structure.

In one example, the invention provides an activator comprising an activated pozzolan. In one example, the pozzolan is selected from a natural pozzolan and a synthetic pozzolan. In one example, the invention provides a natural pozzolan wherein the pozzolan has undergone a process which activates it. In one example, the activation process comprises at least one of application of an electrostatic charge, grinding the pozzolan to a desired particle size and controlling the particle size distribution. Similarly, synthetic pozzolans will have undergone processes that provide high levels of surface activation. This can occur during their production which is typically through thermal activation during production of fly ash or slag or other high temperature processes.

Preferably the activated pozzolans comprised in an activator have a moisture content of less than about 5%. Even though the activators of the present invention can be produced and used with a moisture content of greater than 5%, enhanced stability, mixing and formulation is achieved at lower moisture contents. Therefore, in a further example, the activator comprises a moisture content of less than about 3%. The moisture content may be adjusted to be within this range, or maintained within this range if material obtained is already at the desired moisture content.

The inventors have found that activators combined with natural or synthetic pozzolans act as a binder with surprisingly good workability, strength and durability. These properties enable the binder to replace a portion of cement that is typically used in a concrete mixture. In one example, a concrete composition comprising an activator comprising natural or synthetic pozzolans added at only 1-4% w/w of cementitious material yields a concrete with substantially the same or better workability, strength and durability versus standard cement ranges without activator added. Cementitious material means the total amount of binder material that is active during preparation of the concrete. In one example, the cementitious material comprises Portland cement. For example the inventors have shown the 111 kg of cement can be reduced and replaced with non-active filler components such as sand and aggregate by adding just 7.2 kg of an activator comprising pozzolans to achieve substantially the same strength and durability.

Pozzolans can be described in terms of their chemical composition. The pozzolans are present in activators in a range and in proportions which assist in achieving the chemical composition described below. These activators provide the user with a concrete product with enhanced durability, strength and setting time. The inventors have shown that activators of the invention can be prepared from materials in a wide range of chemical compositions. In some examples, the activator chemical composition comprises SiO₂ at a range from 20-80% by volume of the activator. In some examples, the activator chemical composition comprises Al₂O₃ in a range of 5-40% by volume of the activator. In an alternative embodiment, the invention comprises the following chemical composition range:

| | Chemical | | | Percentage |
|---|---|---|---|---|
| Component | formula | CAS no. | EC no. | w/w |
| Silicon dioxide | SiO₂ | 7631-86-9 | 231-545-4 | 40-80 |
| Aluminium oxide | Al₂O₃ | 1344-28-1 | 215-691-6 | 10-40 |

In one particular example, the chemical composition comprises SiO₂ at a range from 30-40%, and Al₂O₃ in a range from 7-10% by volume of the activator. The above percentages can be achieved using multiple pozzolan minerals, combined in proportions that are able to be ascertained by those of skill in the art and as described herein.

In one example, an activator of the invention comprises a first and second pozzolan portion which comprises different chemical compositions. As referred to herein, a different chemical composition is intended to refer to a difference in the amount of either silicon dioxide or aluminium oxide of at least 5% w/w.

In one example, the invention provides a method of producing an activator composition comprising the steps of:
a. obtaining a first pozzolan portion with a first chemical composition and a second pozzolan portion with a second chemical composition;
b. combining the first pozzolan portion with the second pozzolan portion to form a pozzolan component;
c. mixing the pozzolan component with a plasticiser to produce an activator composition,
   wherein the pozzolan component comprises a chemical composition comprising 20-80% w/w silicon dioxide, and 5-40% aluminium oxide.

In one example, the invention provides a method of producing an activator composition comprising the steps of:
a. obtaining a first pozzolan portion with a first chemical composition and a second pozzolan portion with a second chemical composition;
b. combining the first pozzolan portion with the second pozzolan portion to form a pozzolan component;
c. mixing the pozzolan component with a plasticiser to produce an activator composition,
   wherein the pozzolan component comprises a chemical composition comprising 40-80% w/w silicon dioxide, and 10-40% aluminium oxide.

In one example, the invention provides a method of producing an activator composition comprising the steps of:
d. obtaining a first pozzolan portion with a first chemical composition and a second pozzolan portion with a second chemical composition;
e. combining the first pozzolan portion with the second pozzolan portion to form a pozzolan component;
f. mixing the pozzolan component with a plasticiser to produce an activator composition,
   wherein the pozzolan component comprises a chemical composition comprising 30-40% w/w silicon dioxide, and 7-15% aluminium oxide.

In one example, the invention provides a method of producing an activator for use as an admixture for concrete comprising the steps of:
a. obtaining a first pozzolan portion with a first chemical composition and a first particle size Dv50,
b. obtaining a second pozzolan portion with a second chemical composition and a second particle size Dv50;
c. combining the first pozzolan portion with the second pozzolan portion to form a pozzolan component;
d. mixing the pozzolan component with a plasticiser to produce an activator composition.

The plasticiser may be a powdered plasticiser. In one example, the mixing period is at least five minutes. This ensures that the different materials blend and facilitates the interstitial filling referred to herein which assists in providing a concrete/mortar product with the enhanced properties described herein. The plasticiser may be present at varying concentrations depending on the application of the concrete and the water demand and placement properties. In some example the plasticiser is present at 8-40%, 10-40%, or 10 to 25% w/w of activator. Without wishing to be bound by theory, it is believed that the plasticiser interacts with the pozzolan components to facilitate a stable powdered mixture with properties that enable enhanced reactivity. This enhanced reactivity leads to the unexpected early strength observed in trials outlined in the examples. This unexpected activity of the activator components and optionally additional supplementary cementitious materials added to the mix is believed to be at least partially achieved by the electrostatic activation of activator particles resulting in their reduced clumping, and enhanced interstitial filling as described herein.

In one example, the method of producing an activator for use as an admixture for concrete comprises a step of applying an electrical charge to one or more activator components. The activator components may comprise any one of the activator, the pozzolan component, the first, second or a further pozzolan portion, or the plasticiser.

The activator admixtures of the present invention may include pozzolans and a plasticiser in powdered form. During the mixing process, these components may be subjected to electrostatic forces, which may be generated by a variety of mechanisms. In one example, as the mixture undergoes mechanical agitation, friction between the particles causes them to acquire an electrostatic charge. This phenomenon increases the surface energy of the particles, making them more reactive. Alternatively, an external electrical charge can be applied to the admixture to achieve the same effect, enhancing the activation process further. It is important to distinguish this process of mixing from the process of intergrinding which reduces particle size and can also impart increased reactivity to interground particles.

When the components are mixed, the generated electrostatic forces are believed to result in the particles repelling each other. This repulsion prevents the particles from clumping together, ensuring a uniform dispersion of the pozzolans and plasticiser throughout the concrete/mortar mix. This uniform dispersion assists in achieving a consistent and homogeneous concrete microstructure. An improved microstructure also minimises the occurrence of weak points within the concrete. This results in a more consistent material with improved mechanical properties. Additionally, the uniform dispersion contributes to a reduction of pore size and connectivity within the concrete, which enhances its overall durability and resistance to environmental factors as exemplified in example 4.

Electrostatic activation is believed to significantly increase the chemical reactivity of the pozzolans within the concrete mix. Pozzolans such as those described herein typically react with calcium hydroxide, a by-product of the cement hydration process. This reaction results in the formation of additional cementitious compounds, notably calcium silicate hydrate (CSH) from SiO₂ and CAH from Al₂O₃ which make up the primary binding phase in concrete and are essential for the concrete's strength and durability. This increased formation of CSH and CAH directly correlate with higher compressive and tensile strength in the concrete. By increasing the surface energy of the pozzolans through electrostatic activation, their reactivity is enhanced thus leading to a more efficient and accelerated pozzolanic reaction, producing more CSH and CAH. The presence of additional CSH and CAH improves the overall strength and durability of the concrete, contributing to its long-term performance.

The improved dispersion of pozzolans and plasticiser within the concrete mix, believed to result from electrostatic activation, plays a significant role in reducing the concrete's permeability. The formation of additional CSH and CAH helps to fill the pores within the concrete, decreasing the pore size and connectivity. This reduction in porosity leads to decreased permeability, enhancing the concrete's resistance to water and chemical ingress. Consequently, the concrete becomes more durable and better suited for use in harsh environments. Example 4 describes experiments carried out which exemplify the increased durability and performance of activator containing concrete with respect to water resistance, chloride penetration, and reduction in voids.

Concrete that incorporates the electrostatically activated admixture demonstrates enhanced durability. The increased strength and reduced permeability contribute to the concrete's ability to withstand environmental degradation. This includes improved resistance to freeze-thaw cycles, sulphate attack, and alkali-silica reaction. The enhanced durability makes this concrete suitable for use in a wide range of demanding construction applications, where long-term performance is critical.

In one example, an external electrostatic field is applied to the dry powder form of the activator. The mixture of pozzolans and plasticiser is placed in a chamber equipped with electrodes that generate an electrostatic field with voltages ranging from 20 to 50 kV. The electrodes can deliver a power output of 2 to 10 kW, ensuring a strong and consistent electrostatic field. The flow rate of the powder through the chamber is maintained at a rate which achieves a power delivery of at least 0.1 to 0.6 kWh/kg of activator powder. This power delivery ensures uniform exposure to the electrostatic field and a uniform charge distribution across the particles.

In a further example, the dry powder activator is charged using an electrostatic spraying technique. The pozzolans and plasticiser mixture is fed through an electrostatic spray gun, which imparts a charge to the particles as they are sprayed onto a collection surface. The spray gun operates at voltages of 30 to 60 kV, with a power output of 1 to 3 kW. The flow rate of the powder through the spray gun is controlled at a rate to achieve at least 0.1 to 0.6 kWh/kg of activator powder. The charged particles are collected and subsequently prepared for use in a concrete or mortar mixture.

In another example, the activator comprising pozzolans and a plasticiser is subjected to triboelectric charging in a fluidized bed. The dry powder is fluidised using a stream of air, optionally at a flow rate of 50 to 200 m³/hr. As the particles collide with each other and the walls of the fluidised bed chamber, which are typically lined with a triboelectric material, they become triboelectrically charged. Preferably the voltage generated during this process is between 5 to 25 kV. In one example, the activator is subjected to an electrical charge of between about 0.1 to 0.6 kWh/kg of activator powder. This method utilises the principles of triboelectric charging to generate electrostatic forces, enhancing the properties of the activator for use in concrete.

In one example, the electrostatic charge applied to the activator components is generated through the mechanical mixing process itself. The dry powder form of the activator, comprising pozzolans and a plasticiser, is subjected to mixing in a mixer. The mixer operates at a speed of 1500 to 3000 rpm, generating friction between the particles. This friction induces electrostatic charges. The power output of the mixer can be adjusted between 1 to 5 kW to control the intensity of the mixing process. This method leverages the inherent frictional forces in mixers to induce the electrostatic effect, enhancing the reactivity and dispersion of the activator components. It will be appreciated by those of skill in the art that mixing and application of an electrostatic charge using this method does not require the size reduction of particles that may be achieved through intergrinding. Intergrinding negatively affects particle size distribution within a mixture, causing larger particles to experience a proportionally greater size reduction compared to smaller particles. This leads to an homogenisation of particle sizes which compromises the benefits of using multiple particle sizes achieved through interstitial filling as referred to herein.

In a further example, an electrostatic charge is applied to the activator using a corona discharge. The mixture of pozzolans and plasticiser is passed through a region where a high-voltage electrode generates a corona discharge. The electrode operates at voltages ranging from 40 to 80 kV, with a power output of 2 to 6 kW. The flow rate of the powder through the corona discharge region is maintained at a rate sufficient to achieve an electrical charge of between about 0.1 to 0.6 kWh/kg of activator powder. The ions produced by the corona discharge attach to the activator particles, imparting an electrostatic charge in a controlled and efficient way.

In a further example, the activator components are subjected to electrostatic fluidisation. The pozzolans and plasticiser mixture is placed in an electrostatic fluidised bed where a combination of fluidisation and electrostatic charging occurs. In one example the fluidising air is ionised at a voltage of 15 to 35 kV. The fluidised and ionised air passes through the powder, charging the particles. The power output for ionizing the air is typically between 0.1 to 0.6 kWh/kg of activator powder. This dual action of fluidisation and charging achieves both dispersion and reactivity of the activator components.

In one example, the pozzolan component comprises a chemical composition comprising 40-80% w/w silicon dioxide, and 10-40% aluminium oxide. In a further example, the pozzolan component comprises a chemical composition of 20-80% w/w silicon dioxide, and 5-40% aluminium oxide.

In a further example, the invention provides a method of preparing an activator composition comprising the steps of:
a. obtaining a first natural pozzolan portion with a first Dv50 particle size;
b. combining the first natural pozzolan portion with a second natural pozzolan portion with a second Dv50 to produce an activator composition,
   wherein the activator composition comprises a chemical composition comprising 40-80% w/w silicon dioxide, and 10-40% aluminium oxide, and wherein the first and second Dv50 particle size differs by at least 10 μm.

In one example the method comprises applying an electrostatic charge to the activator composition. In one example, electrostatic charge is applied by way of the power delivery of at least 0.1 to 0.6 kWh/kg of activator powder.

As will be appreciated by the above examples, the unexpected efficacy of the activator when combined with other concrete components is at least partially determined by the chemical and physical properties of the pozzolan component and the activator composition. The pozzolan component may be produced by combining one pozzolan compound with at least one other pozzolan compound to result in the preferred properties described.

In one example, preparation of the pozzolanic component of the activator composition, for example the method and activator of the preceding paragraph, may further comprise the steps of:
a. identifying a chemical composition of at least two pozzolans;
b. calculating the required amount of pozzolan a first pozzolan and a second pozzolan to achieve a chemical composition of the pozzolan component in a pre-determined range;
c. combining the calculated amounts of pozzolans to produce an activator.

The ways in which pozzolan compounds can be selected and combined to result in the inventive compositions are able to be readily determined by those of skill in the art, in accordance with standard testing and combinatorial procedures. Those of skill in the art would calculate the requisite amount of corresponding pozzolan materials to achieve a pozzolan component within the prescribed range of chemical compositions described herein.

Although admixtures are typically provided in a liquid form, it is preferable to formulate and store the activators of the invention when in a dry powdered form. For example, the moisture content of the components or portions of the activator should preferably result in an activator with a moisture content of less than 5%. Moisture content can be measured according to standard methods known to those of skill in the art.

If the moisture content is too high, for example 5% or over, the formulation machinery can malfunction and block due to machinery becoming fouled, especially air pumps designed to transport dry material thorough tubes. Further, when a plasticiser or superplasticiser is used in the activator composition, this component can react with water and partially set or reduce effective surface area of the activator components. This results in decreased efficiency of binding, and difficulty in storage or transportation of the activator prior to concrete formulation.

To achieve the desired moisture content, components of the activator may require drying according to known processes. One unexpected advantage of using pozzolans for the preparation of an activator is that it can be dried if the moisture content rises to be too high, for example over 5%, or 3% depending on the application and stability of the product required. In contrast, cement-containing compositions bind to each other and cannot be used if the material gets wet or beyond a threshold moisture content.

In one example, the activator comprises pozzolan portions which each comprise a moisture content of less than about 5%. In a further example, the pozzolan portions each comprise a moisture content of less than about 3%.

In one example, the activator comprises a moisture content of less than about 5%. In a further example, the activator comprises a moisture content of less than about 3%.

The moisture content may be adjusted to be within this range, or maintained within this range if material obtained is already at the desired moisture content.

The invention described herein comprises an activator comprising a natural or synthetic pozzolan that may have a multi-modal particle size distribution. In one example, the multi-modal distribution comprises at least two distinct peaks of particle size frequency or volume density—i.e. a bi-modal distribution as shown in the figures. In another example, the multi-modal distribution comprises at least three distinct peaks of particle size frequency—i.e. a tri-modal distribution. In some examples, the distribution comprises a multi-modal distribution which is defined as more than two distinct peaks of particle size frequency. For example 4, 5, 6, 7, 8, 9 or 10 distinct peaks.

In one aspect, the invention provides an activator admixture for producing concrete, the activator comprising a pozzolan component and a plasticiser component, wherein the pozzolan component comprises a first pozzolan portion and at least a second pozzolan portion, wherein the first and second pozzolan portions comprise different median particle sizes.

In one example the multi-modal particle size distribution is achieved by adding two or more pozzolan portions, wherein each pozzolan has a Dv50 different to every other pozzolan portion. In one example, the Dv50 differs by at least 10 μm. Although the Dv50 of distinct portions used to formulate the pozzolan component will be different, it will be appreciated that the resultant pozzolan component found in the activator will have mixed portions. Therefore the pozzolan component will have a single Dv50 median particle size but portions with distinct particle size distributions, the median particle size of which can be measured and reported separately. Where particle size analysis indicates that there are distinct particle size distribution peaks (for example in the particle size volume density graphs shown in the figures), these peaks can be attributed as being the original Dv50 values of the pozzolan portions combined to produce the pozzolan component. The difference between the distinct Dv50 values indicates that different particle sizes are present in the composition.

The particle size distributions of the present invention provide unique reactive properties and strength. Without wishing to be bound by theory, it is believed that this enhancement is at least partially explained by the different particle size portions filling interstitial spaces within the other portions to provide an enhanced matrix and therefore enhanced strength. For example, particles from a first pozzolan portion fills at least a plurality of interstices between particles of at least one of a second pozzolan portion and a third pozzolan portion. In some examples, particles of a second portion of particles fills at least a plurality of interstices between a third portion of particles. This unique arrangement of particles contributes to the water resistance, durability, and tensile and compressive strength of the resultant mortar or concrete as observed in the examples. The portions of pozzolan particles described herein may be from natural pozzolans, each with a different chemical composition.

As will be understood by those of skill in the art, the particle size of each particle of a composition will vary about a mean. In some examples, the median of the volume distribution is used to describe the particle size and is referred to as “Dv50” or D (v,0.5). This parameter describes the maximum particle diameter below which 50% of the sample volume exists—also known as the median particle size by volume.

To determine the Dv50, a sample of the material is analysed using a particle size analysis technique. Such techniques will be known to those of skill in the art but by way of example, they may be selected from sieve analysis, laser diffraction, and sedimentation. Alternatively, the particle size may be defined in terms of size and volume density at that size (for example see tables in example 1 and 2 derived according to Test protocol 3).

In the examples described herein, the activator comprises a portion of pozzolan particles comprising a coarse particle size, and a second portion of pozzolan particles comprising an intermediate particle size. In one example, activators described herein may further comprise a third portion of pozzolan particles comprising a fine particle size.

Examples 1a, 1b, 1c, 2a, 2b, 5 and 6 provide example of activators comprising at least bi-modal particle size distributions. Each activator provides enhanced concrete properties (strength and/or workability) compared to control mixes. The activators described may also include a plasticiser. In some examples, the plasticiser comprises a particle size of 100-200 μm. This component of the activator can be observed in the volume density graphs for the examples as a minor peak above 100 μm.

The inventors have found that the specific particle size distribution of natural or synthetic pozzolans included in an activator significantly boost reactivity of pozzolans. This means that the activator can be added at only 1-4% by weight of the cementitious material to the concrete mix to achieve significant improvements of concrete properties.

In some examples, the specific surface area (SSA) of the activator admixture comprises between 350-1000 m²/kg. It will be appreciated by those of skill in the art that the SSA of an admixture, particularly when incorporating pozzolans into concrete, significantly influences both the speed of setting and the strength development of the concrete. The inventors have found that the use of porous particles and a portion of particles of intermediate size (i.e. 0.5-1.5 μm) increases the reactive surface area, thereby accelerating the pozzolanic reaction with calcium hydroxide during cement hydration. Fine particles (i.e. less than about 0.3 μm) are not required to achieve the benefits of the activators described herein. This enhanced reactivity leads to a faster setting time and contributes to early strength gain. Additionally, the higher SSA achieved by porous particles can increase the water demand as these particles absorb more water. The activator admixtures of the invention balance this increased water demand with a plasticiser (water reducer) provided at pre-determined concentrations to ensure that the absorption is balanced by availability of free water for cement hydration. This avoids the undue stiffening of the mix. This balance is exemplified in the examples provided below where the slump (workability) of the activator containing mixes is maintained at a level substantially equivalent to mixes not including activator. This balance ensures that workability and early strength are provided as features of the concrete produced using the activator admixtures of the invention.

In one example, the invention comprises a pozzolan component comprising a mixture wherein at least 90% of particles comprise a particle size between 1-180 μm. In one example at least 50% of the volume of particles of the pozzolan component comprise less than 40 μm i.e. (Dv50 40 μm). In another example at least 50% of the volume of particles of the pozzolan component comprise less than 50 μm i.e. (Dv50 50 μm). In another example the activator may comprise a Dv50 of from 10 to 50 μm). As referred to herein, a “pozzolan component” means the part of the activator composition which is made from pozzolanic compounds i.e. not including plasticiser or any other added, non-pozzolan components.

In one example, the activator comprises a pozzolan component comprising at least two pozzolan portions. In some examples, the activator may comprise a third or further pozzolan with the same or different Dv50. The proportions of the pozzolans can be adjusted by those of skill in the art to achieve the particle size distribution described below. In one example, the particle size distribution comprises:
15-55% of particles are less than 15 μm;
50-80% of particles are less than 40 μm; and
70-100% of particles are less than 90 μm.

In a further example, the particle size distribution comprises:
30-40% of the activator comprises particles less than 15 μm,
50-65% of the activator comprises particles less than 40 μm,
75-90% of the activator comprises particles less than 90 μm.

Example 1a describes an activator (Gamma) comprising natural pozzolans wherein the activator comprises a Dv50 of about 24.2 μm, particle size less than 15 μm made up about 38%, particles less than 40 μm made up about 65%, and particles less than 90 μm made up about 90%.

Example 1b describes an activator (Omega2) comprising natural pozzolans wherein the activator comprises a Dv50 of about 31 μm, particle size less than 15 μm made up 34%, particles less than 40 μm made up 55%, and particles less than 90 μm made up 78%.

In a further aspect, the invention provides a method of producing an activator for use as an admixture for concrete comprising the steps of:
a. obtaining a first pozzolan portion with a first chemical composition and a first particle size Dv50,
b. obtaining a second pozzolan portion with a second chemical composition and a second particle size Dv50;
c. combining the first pozzolan portion with the second pozzolan portion to form a pozzolan component;
d. mixing the pozzolan component with a plasticiser to produce the activator.
   In one example the plasticiser comprises a powdered plasticiser.

In one example, the mixing step is carried out for a period of at least five minutes.

In one example, the activator comprises an intermediate particle size and a coarse particle size. In one example the intermediate particle size peak is in a range of 0.5-1.5 μm and the coarse particle size peak is in a range between 10-80 μm. The examples illustrate this property of the activators of the invention whereby a volume density peak corresponding to intermediate particles is observed in a range of 0.5-1.5 μm and the coarse particle size peak comprises a range between 10-80 μm. The first pozzolan component exhibits a volume density peak of between 0.3 and 1.5% for particles at between 0.5 μm and 1.5 μm and a second pozzolan component exhibits a volume density peak of greater than 3% between 10 and 80 μm. In some examples, a volume density ratio of a first peak to a second peak comprises 1:2 to 1:30, preferably 1:3 to 1:8, wherein the peaks may correspond to the first and second pozzolan portions. These peak ranges may correspond to the Dv50 values of a first and second pozzolan portion.

Accordingly, in one example, the activator comprises a first pozzolan portion which comprises an intermediate particle size with a range of 0.5-1.5 μm and a second pozzolan portion comprises a coarse particle size with a range of 10-80 μm. In another example, the activator comprises a first pozzolan portion which exhibits a volume density peak of between 0.3 and 1.5% for particles at between 0.5 μm and 1.5 μm and the second pozzolan portion exhibits a volume density peak of greater than 3% between 10 μm and 80 μm.

Interstitial filling is a critical factor in optimizing the performance of the concrete mix, particularly when using a powdered plasticiser, extended mixing times, and an activator with varying particle sizes. Where the plasticiser comprises a powdered form, the intermediate particles enhance the interstitial filling between larger cement and aggregate particles. This improved packing density reduces voids and enhances the workability, compaction, and ultimately, the strength and durability of the concrete.

In examples where the mixing step is carried out for a period of at least five minutes, the extended mixing time ensures the uniform distribution of both intermediate and coarse particles throughout the mix. This uniformity is essential for effective interstitial filling, which minimizes segregation and leads to a more homogenous concrete structure with superior mechanical properties.

In examples where the activator comprises an intermediate particle size and a coarse particle size, with the intermediate particle size peak ranging from 0.5-1.5 μm and the coarse particle size peak ranging from 10-80 μm, the inventors have found that this combination of particle sizes facilitates optimal interstitial filling. The intermediate particles effectively fill the gaps between the coarse particles, resulting in a densely packed microstructure. This dense packing reduces the porosity of the concrete, leading to increased strength, reduced permeability, and enhanced overall durability of the concrete product.

Plasticisers, “water reducers”, or “superplasticisers” are chemical compounds used in concrete to improve the workability of fresh concrete. When added to the concrete mixture, plasticisers reduce the amount of water required for proper workability, which helps to improve the strength and durability of the concrete by reducing water-cement ratio and minimising porosity, cracking, and shrinkage. Unless the mix is “starved” of water, the strength of concrete is inversely proportional to the amount of water added or water-cement (w/c) ratio. Therefore, in order to produce stronger concrete, less water is added. To avoid “starving” the mix, it may be necessary to use plasticisers or superplasticisers.

Plasticisers work by adsorbing onto the binder (e.g., cement) particles and creating a repulsive force between them, which helps disperse the particles and reduce the viscosity of the mixture. This results in a more fluid and cohesive concrete mixture that can be easily moulded or placed without segregation or bleeding.

Different types of plasticisers are available, including lignosulfonates, sulfonated melamine formaldehyde condensates, naphthalene sulfonate formaldehyde condensates, and polycarboxylates. Each type of plasticiser has its own specific properties and benefits, and the selection of a plasticiser depends on the required workability, strength, and durability of the concrete mixture.

In one example, the activator comprises a plasticiser. The inventors have found that the plasticiser and a pozzolanic mix with defined properties (particle size distribution and chemical composition) together create a synergistic effect that results in speeding up the pozzolanic reaction in concrete by two to three times. As a result, concrete containing activator comprising plasticiser plus pozzolans gains strength faster at each age of strength setting.

Accordingly, in some examples, the activator admixture described herein comprises at least one of: a polycarboxylate plasticiser; a naphthalene plasticiser, a superplasticiser; a lignosulphonate plasticiser; a dry form plasticiser; and a dry powder polycarboxylate superplasticiser.

In one example, the activator according to the present invention comprises a polycarboxylate (PCE) plasticiser. Use of pozzolans in the activator can also increase viscosity of the mix and can reduce workability. Therefore, to counteract this effect, the activators of the present invention may comprise a plasticiser.

Plasticisers also include superplasticisers or “high range water reducers”. Superplasticisers provide a higher rate of water reduction while maintaining strength. In one example, the plasticiser used in the activators described in herein is a superplasticiser, otherwise known as a high range water reducer. Although the activators of the invention may be prepared without a plasticiser, it will be appreciated that this will significantly reduce the workability due to the limited ability to reduce water. Strength would also be compromised in mixes without plasticisers. The activators described herein may be prepared without a plasticiser which is then added subsequently by the concrete formulator rather than the activator manufacturer. This is particularly the case where specialised plasticisers are required, for example for underwater structures, high strength structures, or corrosion resistant concrete.

In many examples of concrete mixtures, liquid plasticisers are added. The inventors have however found that the activator compositions of the present invention show particular efficacy when a plasticiser in dry form is used. In one example, the plasticiser of any activator or concrete mixture described herein comprises a dry powder plasticiser. In this example, the plasticiser may comprise a polycarboxylate plasticiser. The plasticiser may comprise a superplasticiser and may be a polycarboxylate superplasticiser, again preferably in dry powdered form. Dry powdered format plasticiser comes in the form of granules or powder, which can be easily measured, stored, and mixed with other concrete ingredients. In contrast, liquid plasticisers can be messy to handle and may require special containers or precautions for storage and transportation. In addition, powdered plasticisers provide advantages in being able to blend with the dry format pozzolans and disperse evenly throughout the mixture. They enable the preparation of the activator without having to measure and handle liquids during concrete preparation. The powdered format plasticisers offer better control over dosage compared to liquid plasticisers. They are also easier to measure and enable adjustment of the amount of dry powder plasticiser added to the concrete mix, ensuring precise and consistent results. Liquid plasticisers, on the other hand, can be more difficult to measure accurately, leading to variations in the plasticising effect.

In one example, the activator comprises a plasticiser at a percentage (w/w) of from about 8% to 40% or 10% to about 40%. In some examples, this range is about 10% to about 25%, depending on types of pozzolans and the required purpose of the concrete. In another example, the activator comprises a ratio of pozzolan component to plasticiser at a ratio of from 11:1 to 1.5:1, or 9:1 to 1.5:1 or 9:1 pozzolan: plasticiser to about 3:1 pozzolan: plasticiser. In another example, the plasticiser is added to the activator at 8-40% w/w of the activator. It will be appreciated by those of skill in the art that the addition of plasticiser at such high concentrations in the activator admixture is a clear indicator that the activator is not a major portion of the concrete mixture; instead, it represents a minor proportion of the concrete composition.

It is desirable for the plasticiser to be prepared with a weight average particle size which achieves maximum efficacy in adsorbing onto, and mixing with the natural pozzolan portions of the activator. To achieve these improvements in reaction efficiency and mixing, in one example, the plasticiser present in the activator has a Dv50 of from about 50-500 μm. In another example, the plasticiser present in the activator has a Dv50 of from about 100-200 μm.

In one example, there is provided an activator for use as an admixture for concrete comprising:
a) a pozzolan component comprising at least two pozzolans comprising distinct particle sizes and chemical compositions; and
b) a powdered plasticiser with a particle size from 50-500 μm;
   wherein the pozzolan component and plasticiser have been mixed for over 5 minutes. Effective mixing of the activator components is required to provide a stable admixture composition for addition to other concrete components.

There is a prevailing view in the art that pozzolanic concrete has slower strength gain, especially early strength development when compared to ordinary concrete prepared using Ordinary Portland Cement (OPC). Typically, ordinary concrete (using OPC) exhibits faster early strength development within the first few days after casting. This is due to the rapid hydration reaction of the Portland cement. Pozzolanic concrete has in the past been associated with slower early strength development because the pozzolanic reaction is slower to start. The pozzolanic materials react with calcium hydroxide (a byproduct of cement hydration) to form additional calcium silicate hydrate (C-S-H), but this process takes more time to initiate compared to the hydration of OPC.

The inventors have found that the powdered activators of the invention comprising a combination of components including a plasticiser and a pozzolanic mix with properties referred to herein, (for example particle size distribution, specific surface area, electrostatic charge and chemical composition) together create a synergistic effect that is achieved through interaction of the plasticiser and pozzolans, and pozzolans with each other. This speeds up the pozzolanic reaction in concrete by two to three times and the strength of concrete containing activator as an admixture is accelerated at each age of strength setting. Further, the final strength of concrete containing activator is higher than that of concrete without the activator.

The synergistic effect further creates denser packing of particles achieved by the interaction of the plasticiser and pozzolans, and pozzolans with each other which leads to increased strength and durability of the hardened concrete. The additional reactive cementitious compounds formed through pozzolanic reactions contribute to improved compressive strength, reduced permeability, and enhanced resistance to chemical attack. Thus, both chemical and mechanical properties of pozzolans are important to achieve the synergistic effect and improve hardened concrete or mortar properties.

Another example of the efficacy and synergism of activators according to the present invention is demonstrated by the small dosage of only 1-4% activator w/w of cementitious material required to reduce cement content in concrete by 20-50%, without compromising the compressive strength of concrete at each day of strength setting.

Another example of the efficacy and synergism of the present invention is the enhanced properties of concrete containing natural or synthetic pozzolans as fillers when activator is used. Hence, cement reduction of over 30% compared to a standard concrete mix is achieved by adding natural or industrial pozzolans to the concrete mix together with the activator.

In one example, a 20 MPa concrete mixture may typically require 250 kg of cement which acts as a binder to create strength in the final set concrete. 30% of the 250 kg cement (i.e. 75 kg) may be removed and replaced with an activator of the present invention at between 1-4% of the remaining cement volume. In this example, 1-4% of the remaining 175 kg equals 2.5-7 kg of activator. The remaining mass of the cement (i.e. equivalent volume to 168-172.5 kg) is then replaced by either a) substantially inactive filler, for example aggregate and/or sand, and/or b) supplementary cementitious materials. In this example, the embodied carbon emissions of the resultant concrete are substantially reduced because the cement component (which has the highest embodied carbon) is substantially reduced.

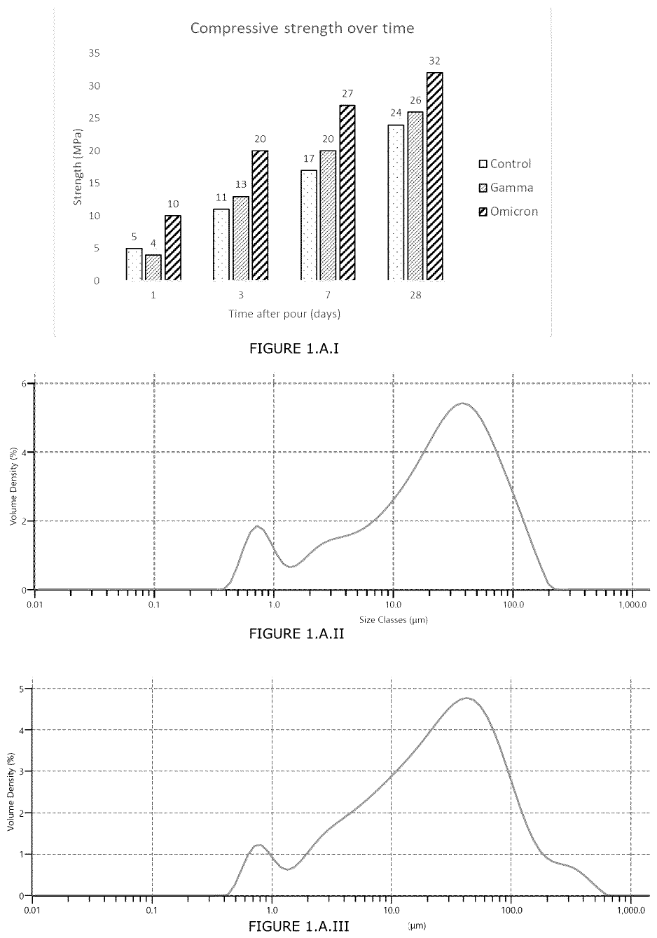

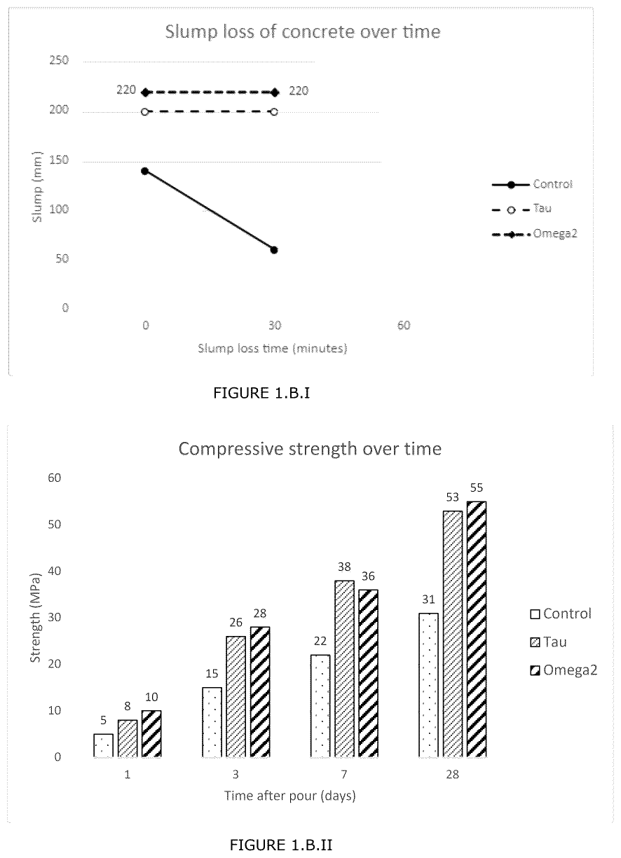

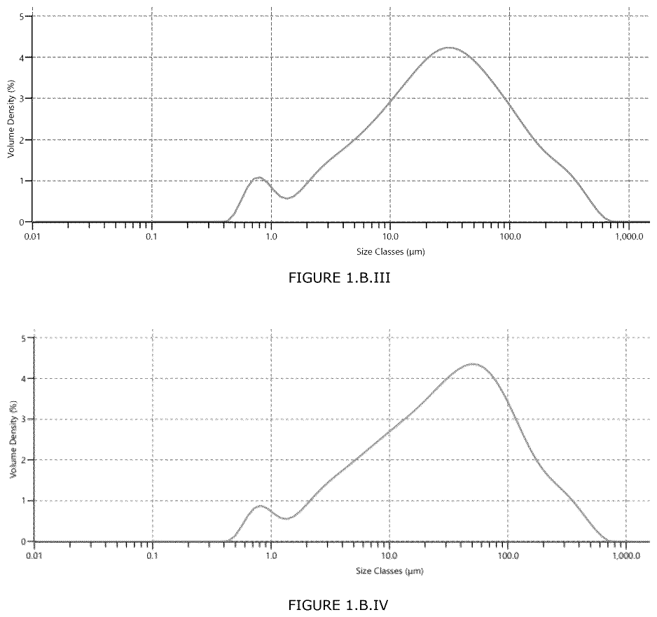

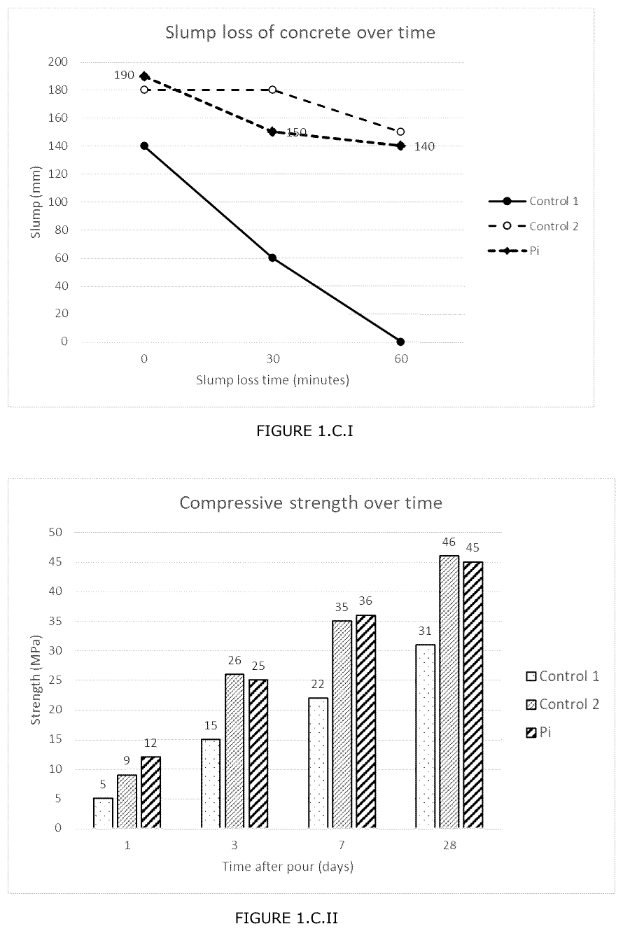

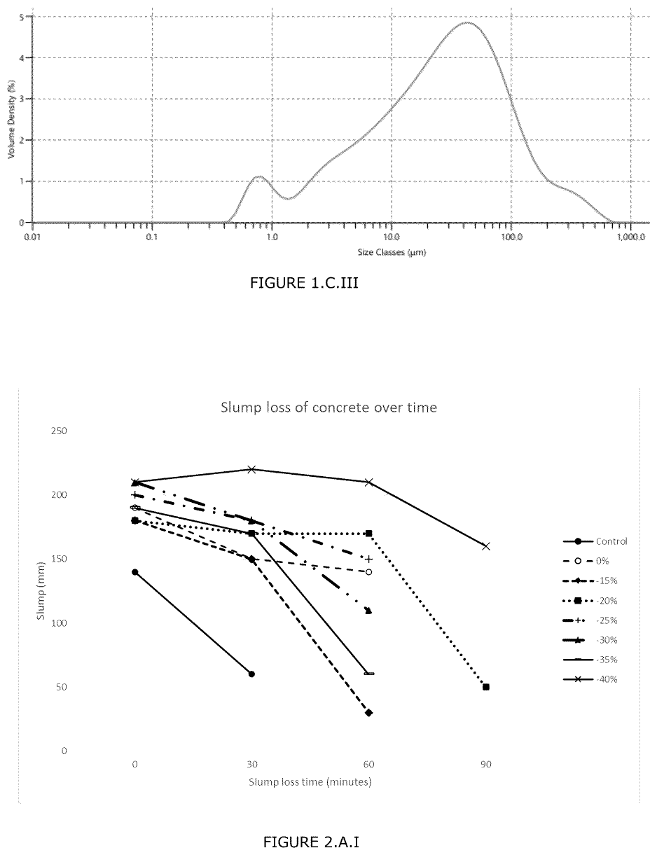

Example 1c demonstrates this effect using an activator “Pi” containing a specific particle size distribution of natural pozzolans. The cement used in the “control 2” mix is 386 kg/m³ compared to 275 kg/m³ in the activator mix—a 28.8% reduction in cement mass. The bulk of the concrete is made up by inactive filler—i.e. aggregate. The concrete strength as shown in FIG. 1.c.ii is substantially the same at day 1,3,7 and 28 for the activator and control mixes.

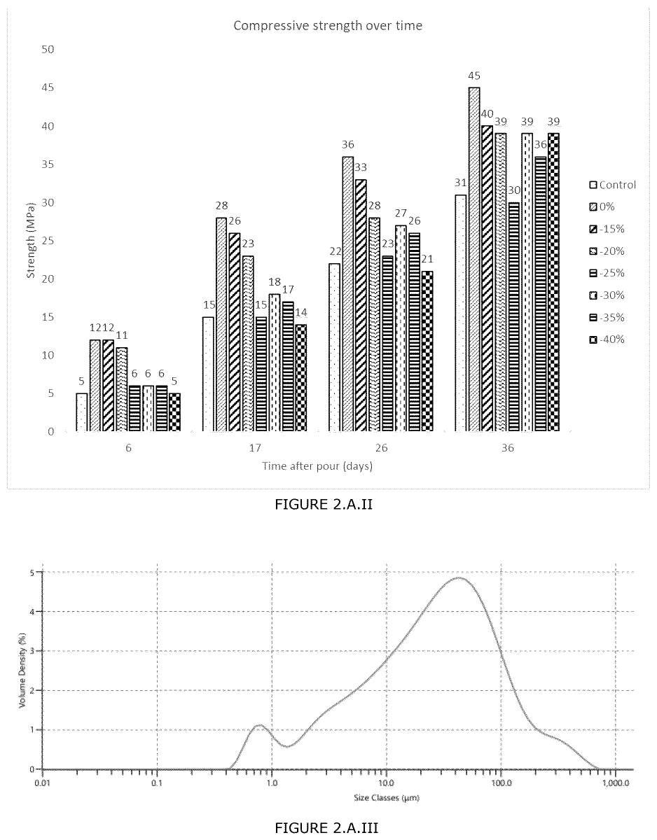

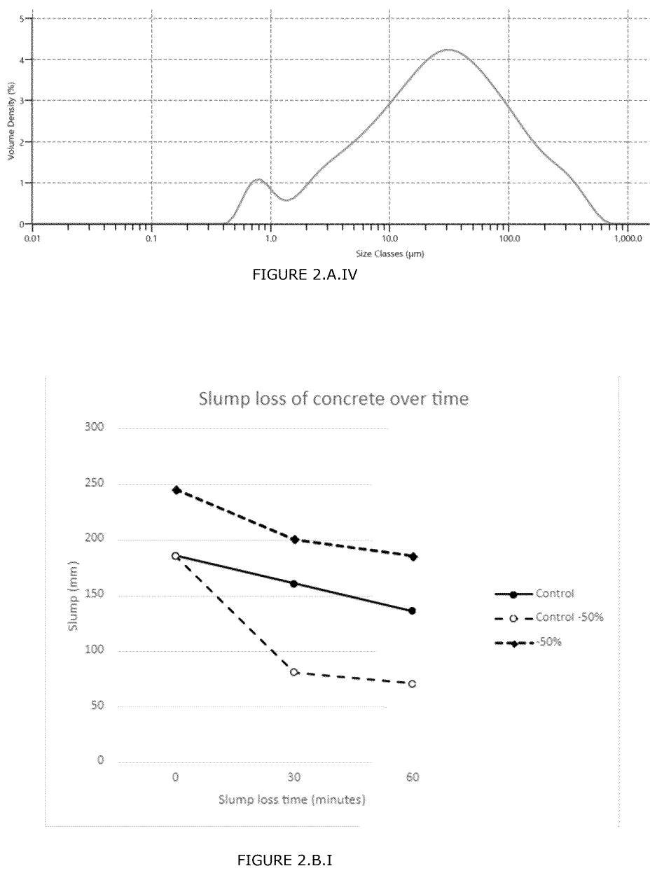

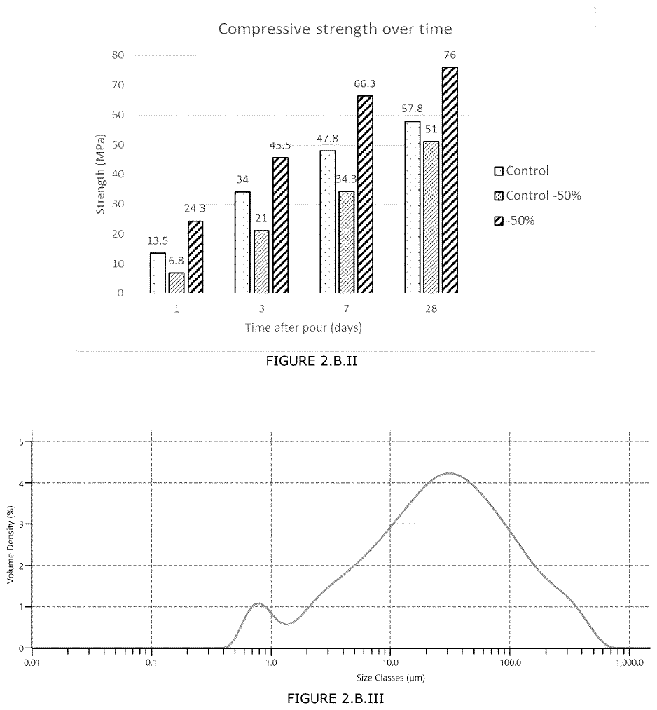

Also in example 2a (FIG. 2.a.ii), when the same amount of cement is included in the control and the activator mix (see control 1-275 kg/m³), the strength of the concrete is increased in the activator mix-day 1=240% stronger, day 3=187% stronger, day 7=163% stronger, day 28=145% stronger.

The reduced-cement concrete mixture also exhibits enhances flowability, cohesiveness, and stability, making the mix easier to pump, place, and finish. This is particularly beneficial in large-scale construction projects where concrete needs to be transported over long distances or in challenging environments.

Measuring the chemical composition of a natural pozzolan is an important step in determining its suitability for use in concrete activators. A representative sample of the natural pozzolan is prepared for analysis which may involve drying the sample and grinding it to a fine powder to ensure homogeneity. Several methods for measuring the chemical composition of natural pozzolans will be known to those of skill in the art. These include X-ray fluorescence (XRF), atomic absorption spectroscopy (AAS), inductively coupled plasma-optical emission spectroscopy (ICP-OES), and scanning electron microscopy-energy dispersive X-ray spectroscopy (SEM-EDX).
XRF is a commonly used technique because it is fast, accurate, and can analyze a wide range of elements. In this method, a sample of the natural pozzolan is bombarded with X-rays, causing the atoms in the sample to emit characteristic fluorescent X-rays. The energy and intensity of these X-rays are detected and analyzed to determine the elemental composition of the sample.
Atomic absorption spectroscopy (AAS) involves vaporizing the sample and passing a beam of light through the vapor. The absorption of the light by the sample is proportional to the concentration of the element being analyzed, allowing for quantitative analysis of the element.
Inductively coupled plasma-optical emission spectroscopy (ICP-OES) involves vaporizing the sample in an argon plasma and analyzing the light emitted by the excited atoms using a spectrometer. The intensity of the emitted light is proportional to the concentration of the element being analyzed.
Scanning electron microscopy-energy dispersive X-ray spectroscopy (SEM-EDX) is a microscopy technique that involves viewing the natural pozzolan particles under a microscope and measuring the X-rays emitted by the atoms in the sample. The chemical composition of the sample can be determined by analyzing the X-ray spectra.

Once the chemical composition data has been obtained, it can be analyzed using statistical software to determine the concentrations of different elements and their relative proportions. The results are then used to evaluate the quality of the natural pozzolan and optimize its use in concrete mixtures.

Measuring the particle size distribution of natural pozzolans is an important step in determining their suitability for use in concrete, as well as their potential performance in terms of strength, durability, workability, and aesthetics. Several methods for measurement of particle size and particle size distribution will be known to those of skill in the art. A first step is to prepare a sample of natural pozzolan for analysis. This typically involves taking a representative sample of the natural pozzolan and drying and sieving the sample to remove any impurities or oversized particles.

There are several methods available for measuring particle size distribution, including laser diffraction, sedimentation, and microscopy.
Laser diffraction is a commonly used technique because it is fast, accurate, and can measure a wide range of particle sizes. In laser diffraction, the natural pozzolan sample is dispersed in a liquid medium, such as water or alcohol, and passed through a laser beam. The laser light is scattered by the particles in the sample, and the scattering pattern is captured by a detector. The intensity of the scattered light is related to the size of the particles, and the distribution of sizes is calculated using mathematical algorithms.
Sedimentation: In sedimentation analysis, the natural pozzolan sample is dispersed in a liquid medium and allowed to settle under gravity. The settling rate of the particles is related to their size, and the particle size distribution is calculated using mathematical equations.
Microscopy: Microscopy techniques involve viewing the natural pozzolan particles under a microscope and measuring their size manually. This method can be time-consuming and labour-intensive but can provide high-resolution images and accurate measurements.

Once the particle size distribution data has been obtained, it can be analysed using statistical software to determine the mean particle size, the spread of the distribution, and other parameters that may be of interest.

In one example, activators of the present invention may be prepared using the following steps:
1. Measurement of moisture content of each pozzolan portion and adjustment to be less than 5%. Alternatively, the moisture content of the pozzolan mixture may be adjusted to be less than 3%. This preferred range of moisture content enables the mixing and storage of the components and to ensure there is substantially no water in the mix to react with the plasticiser in the Activator.
2. Chemical composition analysis and amendment—pozzolans (also referred to herein as pozzolanic material) are analysed to identify their chemical composition. The percentage by weight or molar concentration of each chemical compound of interest is determined in each pozzolanic material. The proportions of different pozzolans are then amended to achieve the required chemical composition (within the ranges specified herein).
3. Particle size determination and amendment—The particle size is adjusted to be in a specified range for each pozzolan of a specified chemical composition. Larger pozzolan particles may be size-reduced e.g. by grinding to form a ground pozzolan mixture of a particular particle size. The ground pozzolan may be obtained as a waste “side-stream” from larger pozzolan rocks used for other purposes.
4. Measurement of particle size distribution and amendment if necessary—The distribution of particle sizes is important to balance the reactivity and setting speed of the concrete. The distribution is controlled by combining pozzolan sources with known particle size distribution with other sources to provide a required distribution comprising polydisperse particle sizes.
5. Mixing of activator components and a plasticiser in required proportion—the activator components referred to herein are mixed in a suitable mixing apparatus. This mixing step should be carried out for at least 5 minutes to achieve sufficient mixing of the different activator components. A further processing step of grinding, for example in a ball mill is undesirable because it results in an inconsistent particle size reduction (i.e. larger particles will be size reduced to a larger extent than smaller particles which can upset the balance of particle size distribution in the activator product. This further grinding step also increases energy demand and concomitant embodied carbon.

In one example, the activator is in a liquid form. In this example, the method of preparation comprises mixing the dry activator mixed with a suitable solvent, for example water, at an appropriate ratio for storage, transport and final formulation with other concrete components. In one example, the liquid activator is formulated with the solvent at a w/w ratio of activator: solvent about 1:2, about 1:1, about 2:1.

A key advantage of using a dry form activator is to maintain a stable activator: solvent ratio on preparation. Where liquid forms of the activator are prepared, for example according to the above formulations, the activator: solvent ratio may change due to evaporation of the solvent, or settling of active components and incorrect mixing prior to final formulation.

In some embodiments, the activator components are blended without intergrinding. Intergrinding in this context refers to the grinding of various components to effect particle size homogenisation, reduction and mixing. Intergrinding the components is energetically costly which can increase the overall carbon emissions. The presently provided activators of the invention may comprise components that are blended rather than interground.

Heating of the activator components is energetically costly which can increase overall carbon emissions associated with production of concrete. The present invention does not require thermal treatment of the activator. Therefore in some examples described herein, the activator is not heated prior to mixing.

Concrete is composed of three key components-aggregates, cement and water. Admixtures including plasticisers are also used most of the time. Aggregate provides mechanical stability by acting as a filler material, binding the cement paste together and forming a solid matrix. The strong interlocking nature of aggregates enhances the overall compressive strength and load-bearing capacity of concrete structures. Since aggregates occupy a significant volume in concrete, they help to reduce the cost by replacing cement with aggregates.

Aggregates are described herein as coarse or fine. Coarse aggregates are particulates that are greater than about 4.75 mm. The usual range employed is between 9.5 mm and 37.5 mm in diameter. Fine aggregates are usually sand or crushed stone that are less than 9.55 mm in diameter. Typically, the most common size of aggregate used in construction is 20 mm. A larger size, 40 mm, is more common in mass concrete.

One form of fine aggregate is sand. Sand is a granular material composed of small particles with a particle size ranging from 0.0625 mm to 2 mm in diameter. In its natural form, it is found in various geological formations, such as riverbeds, beaches, deserts, and quarries. As a fine aggregate in concrete, it fills the voids between larger aggregates to enhance the workability and cohesiveness of the concrete mix. Those of skill in the art will appreciate that the term “sand” also encompasses fine aggregates that are not of mineral origin such as sand substitutes. These include, for example, manufactured sand, washed bottom ash, glass powder or quarry dust. Sand is a relatively inexpensive and available component compared to other concrete components. In some examples of the invention provided herein, cement is replaced with sand, coarse aggregates plus activator to make up the solids proportion when using lower cement proportion. Sand also has a much lower carbon footprint than cement, is cheaper and requires less processing.

Water plays a vital role in hydrating the cement to form a strong and durable binder. This binder acts to bind the aggregates and sand together and hardens over time, creating a solid and cohesive structure. Water reacts with plasticisers to modify the rheology and flow characteristics of the concrete. Water is also involved in the curing process, where it helps maintain the necessary moisture levels for proper cement hydration and strength development. The water-to-cement (w/c) ratio is a critical parameter that affects the strength, durability, and overall performance of concrete. It represents the amount of water relative to the amount of cement in the mixture. The w/c ratio should be carefully controlled to achieve the desired strength while maintaining adequate workability and durability. An excessive water content can weaken the concrete and lead to increased porosity, reduced strength, and increased permeability.

In one example the activators of the invention allow a reduction in water usage compared to preparation of concrete without activators (but with plasticisers or water reducers). The water reduction achieved with the activator can range between 10-45%, as compared to control concrete with and without the plasticisers/water reducers. On top of contributing to strength increase in concrete, this feature of the activator has particular utility in environments where water is scarce, or where substantial water usage is undesirable (e.g. for cost factors).

In one example the cementitious materials in the binder are selected from Portland cement and supplementary cementitious materials.

Supplementary Cementitious Materials (SCMs) are finely divided materials that are used in conjunction with Portland cement in concrete or mortar mixtures. The proportion of SCMs in a concrete mix is however limited by the inherently unreactive properties of most SCMs. Some SCMs are used as non-reactive fillers rather than reactive components. Where high substitutions of SCMs are attempted in concrete mixtures, substandard concrete properties are observed such as reduced compressive strength, reduced durability, increased setting time and reduced workability.

In one example, SCMs comprise natural pozzolans e.g. pumice, fly ash, slag, silica fume, metakaolin (thermally activated kaolin clay), and rice husk ash. Natural Pozzolans are also used as SCMs but sometimes presented as fillers, rather than active components. SCMs may further comprise a material selected from the group consisting of Trass flour, recycled glass, fly ash, bottom ash, cenospheres, glass bubbles, slag, clays, calcined clays, partially calcined clays, kaolinite clays, lateritic clays, illite clays, crystalline silica, silica flour, cement kiln dust, volcanic rock, natural pozzolans, mine tailings, diatomaceous earth, zeolite, shale, ground vitrified pipe, agricultural waste ash, ground granulated blast furnace slag, bentonite, pumice, and any combination thereof. In some examples, the activator admixtures of the invention are provided in combination with one or more pozzolan SCMs. In these examples, the activator activates the SCM to provide an SCM with enhanced reactivity versus the SCM alone. This important effect of the activators of the invention is shown in example 8 and 10 and enables cement (high embodied carbon) to be replaced by SCMs (lower embodied carbon) without losing the binding capability that is typically observed when substituting cement with SCMs.

Portland cement is a manufactured material produced via a process called clinkerisation, which involves heating a mixture of limestone, clay, and other minor ingredients at high temperatures. The resulting clinker is then ground into a fine powder, which is known as Portland cement. The chemical composition of Portland cement primarily consists of calcium silicates, including tricalcium silicate and dicalcium silicate. These compounds are responsible for the cement's ability to harden and gain strength through hydration when mixed with water. Other compounds, such as calcium aluminate, calcium sulfate (gypsum), and minor additives, may also be present, depending on the specific cement type. In some examples, the cementitious material comprises a Portland cement suitable for wells. Portland cements that are suited for use in the disclosed compositions include, but are not limited to, API Class A, C, G, H, low sulphate resistant cements, medium sulphate resistant cements, high sulphate resistant cements, other construction cements, or combinations thereof. The API class A, C, G, and H cements are classified according to API Specification 10. Additional examples of Portland cements suitable for use in the present disclose include, without limitation, those classified as ASTM Type I, II, III, IV, or V as described below. In some examples, the cementitious material comprises a class C cement. In some examples, the cementitious material comprises a class G cement. For Portland cement types, ASTM C150 describes:

| Cement Type | Description |
|---|---|
| Type I | Normal |
| Type II | Moderate Sulfate Resistance |
| Type II (MH) | Moderate Heat of Hydration (and |
| | Moderate Sulfate Resistance) |
| Type III | High Early Strength |
| Type IV | Low Heat Hydration |
| Type V | High Sulfate Resistance |

When water is added to Portland cement, it undergoes a series of exothermic chemical reactions known as hydration. During hydration, the cement particles react with water, forming calcium silicate hydrate (C-S-H) gel and other compounds. This gel acts as a binder, binding the aggregates together to create a solid and durable concrete matrix.

Examples 1 and 2 relate to preparation of a concrete mix with compressive strength of 20, 25 and 40 MPa. The effects of the Activator and SCMs described in these examples are applicable to other concrete strengths. Those of skill in the art will be readily able to determine the respective modifications to the concrete mixes described herein to achieve concrete of different tensile strength. In one example, the invention provides activators and concrete formulations suitable for the production of 20 MPa, 25 MPa, 30 MPa, 35 MPa, 40 MPa or 50 MPa concrete. In general terms:

20 MPa concrete:
Non-structural applications such as levelling beds, pathways, and minor construction works. Foot traffic i.e. footpaths and house slabs
   25 MPa concrete:
Residential Buildings for elements like footings, slabs, and non-structural walls.
Lightly Loaded Pavements: It can be used for pathways, driveways, and lightly trafficked areas where heavy loads are not expected.

### 35 MPA Concrete:

Residential and Commercial Construction: Grade 35 concrete is suitable for a wide range of applications, including foundations, beams, columns, and structural walls in both residential and commercial buildings.
Light Industrial Floors: It can be used for warehouse floors or light industrial facilities where moderate strength and durability are required.

### 40 MPA Concrete:

High-Rise Buildings: Grade 40 concrete is commonly used in the construction of tall buildings, providing the required strength for structural components like columns and cores.
Bridges and Infrastructure: It is suitable for bridge decks, piers, abutments, and other critical infrastructure components where higher strength and durability are necessary.
Heavy-Duty Industrial Floors: Grade 40 concrete is used in industrial settings with heavier loads and higher abrasion resistance requirements.

### 50 MPA Concrete:

High-Performance Structures: Grade 50 concrete is employed in structures where exceptional strength, durability, and resistance to aggressive environments are crucial, such as high-rise buildings, bridges, and marine structures.
Precast Elements: It is commonly used in the production of precast concrete elements, such as precast beams, columns, and panels, due to its high strength and early strength development.

The ratio of cement to aggregates is adjusted in higher grade concrete to provide a higher proportion of cement which contributes to achieving the increased strength. Cement is the binding agent in standard concrete, and it contributes significantly to its strength therefore higher cement content enables the product to withstand higher loads and stresses.

In some examples, the activator and associated inventions described herein enable higher grade concrete to be prepared using the same or lower amount of cement.

In other examples, the activator and associated inventions described herein enable concrete of the same grade to be prepared using a lower amount of cement compared to standard concrete mixtures.

The water-to-cement ratio may also be reduced at higher grades to ensure better hydration and strength development. The ratio of fine aggregate to coarse aggregate may be adjusted. Also, larger aggregate sizes are used for higher-grade concretes, while smaller aggregate sizes are used for lower-grade concretes. Lower-grade concretes (e.g. 20-25 Mpa) typically use smaller aggregate sizes, such as fine sand and small-sized coarse aggregates. These sizes contribute to improved workability and better bonding between cement and aggregates. Moderate-Grade Concretes (e.g., 35 MPA and 40 MPA) use a balanced combination of fine and coarse aggregates. This helps achieve a good balance between workability and strength. The sizes of the aggregates are typically larger than those used in lower-grade concretes but not as large as in higher-grade concretes. Higher-Grade Concretes (e.g., 50 MPA and above) incorporate larger aggregate sizes. Coarse aggregates with larger particle sizes are used to enhance the strength and load-bearing capacity of the concrete. These larger aggregates provide greater interlocking and mechanical properties, resulting in a higher-strength concrete.

Concrete properties can be measured to ensure that the material is suitable for its intended use and meets the required standards and specifications. Specific measurements of concrete properties include:
Compressive strength—the ability of the material to resist compressive forces. Compressive strength is measured by subjecting a test specimen of concrete to compressive loads until it fails. The maximum load that the specimen can withstand is recorded as the compressive strength of the concrete (in kilo Newtons kNt or Mega Pascals MPa).
Tensile strength: This refers to the ability of concrete to resist tension or stretching forces. Tensile strength is typically much lower than compressive strength, and it can be measured using various test methods, such as the splitting test or the flexural test.
Durability: This refers to the ability of concrete to resist deterioration over time due to various factors such as exposure to moisture, chemicals, and freeze-thaw cycles. Durability can be measured using various test methods, such as the water absorption test, the sulphate resistance test, and the freeze-thaw resistance test.
Workability: This refers to the ease with which concrete can be mixed, placed, and finished. Workability can be measured using various test methods, such as the slump test, the flow test, and the compacting factor test.
Density: This refers to the mass per unit volume of concrete and is typically measured using a density meter or by calculating the mass and volume of a test specimen.

The time it takes for the concrete mixture to begin to stiffen and lose its workability is termed the setting time. The setting time of pozzolanic concrete is an important factor that can affect its overall performance and durability. In a construction setting, timeframes and costs can also be dictated by the setting time of the concrete. A longer setting time is often beneficial for pozzolanic concrete, as it can allow more time for the mixture to fully hydrate and for the pozzolan to react with the cement, resulting in a stronger and more durable final product. A longer setting time can also be beneficial for workability, allowing more time for the mixture to be properly placed and finished before it begins to set. This can be particularly important in large or complex construction projects where the concrete needs to be placed quickly and efficiently, but also needs to maintain its workability long enough to be properly finished.

In some circumstances, a shorter setting time can be beneficial, such as in colder weather or in applications where the concrete needs to be load-bearing or supporting weight quickly. The inventors have found that activators comprising pozzolans can actually result in a decrease in the initial setting time and therefore unexpectedly provide early strength.

The invention provides concrete compositions comprising activators as described herein. The concrete compositions may be prepared according to mixing processes known by those of skill in the art, and using equipment typically used in the art. Concrete compositions comprise at least a coarse aggregate, a fine aggregate and a binder. While those of skill in the art will be able to determine specific concrete mixtures according to the materials and application of the concrete, the following non-limiting examples provide ranges of concrete and activator components that may be present:

| Composition | Component | Percentage |
|---|---|---|
| Concrete | Coarse aggregate | 20-60% of concrete composition (w/w) |
| | | not including water |
| Concrete | Fine aggregate | 20-60% of concrete composition (w/w) |
| | | not including water |
| Concrete | Binder | 10-20% of concrete composition (w/w) |
| | | not including water |
| Binder | Activator | 1-4% of binder (w/w) not including |
| | | water |
| Binder | Cementitious | 96-99% of binder (w/w) not including |
| | materials | water |
| Cementitious | Portland cement | 0-100% of cementitious materials (w/w) |
| material | | not including water |
| Cementitious | Supplementary | 0-100% of cementitious materials (w/w) |
| material | cementitious | not including water |
| | materials | |
| | (SCMs) e.g. | |
| | natural or | |
| | synthetic | |
| | pozzolans | |
| Activator | Natural or | 60-92% of activator (w/w) not including |
| | synthetic | water |
| | pozzolans | |
| Activator | Plasticiser | 8-40% of activator (w/w) not including |
| | | water |

In one example, the coarse aggregate and fine aggregate combined comprise 60-80% of the composition.

In one example, the invention provides a concrete composition comprising:
a. an activator;
b. cementitious material; and
C. aggregate.

As will be understood by those of skill in the art, the binder required of all concrete compositions is provided for in this composition by combining the cementitious material with the activator. In the example above, the activator is provided at between 1-5%, or about 1%, 2%, 3% or 4% of total dry weight of cementitious materials.

The activator in the above concrete composition may be an activator as described anywhere within the specification as an activator of the invention. In particular examples, the activator may comprise one or more properties selected form the group consisting of at least a bi-modal particle size, natural or synthetic pozzolans; a chemical composition comprising 40-80% silicon dioxide and 10-40% aluminium oxide; Dv50 of less than 40 μm; or a particle size distribution defined by:
a. 30-40% of the activator comprising particles less than 15 μm;
b. 50-65% of the activator comprising particles less than 40 μm; and
c. 75-90% of the activator comprising particles less than 90 μm.

In one example, the activator may comprise one or more properties selected form the group consisting of at least a bi-modal particle size, natural pozzolans; a chemical composition comprising 40-80% silicon dioxide and 10-40% aluminium oxide; Dv50 of less than 40 μm; or a particle size distribution defined by:
a. 30-40% of the activator comprising particles less than 15 μm;
b. 50-65% of the activator comprising particles less than 50 μm; and
c. 75-90% of the activator comprising particles less than 90 μm.

The cement quantity is typically determined by the mass of cement in kg.

In one example, the invention provides a method of preparing a reduced cement concrete composition comprising:
a. determining a quantity of cement required for a concrete mixture;
b. reducing the cement quantity by a reduction factor to provide a reduced cement quantity;
C. determining an activator quantity based on the reduction factor;
d. determining a filler quantity based on the reduction factor;
   wherein the activator comprises an activator as described herein.

In one example, the reduction factor is selected from the group consisting of at least about 5%, at least about 10%, at least about 15%, at least about 20%, at least about 25%, at least about 30%, at least about 35%, at least about 40%, at least about 45%, at least about 50%, at least about 55%, or at least about 60%. In one example, the reduction factor is selected from the group consisting of <10%, <20%, <30%, <40%, <50% or <60%. In one example, the reduction factor is 10% to 50%

In one example, when the reduction factor is less than or equal to about 35%, the activator quantity comprises at least 3% w/w of total cementitious material. In another example, when the reduction factor comprises less than or equal to about 50%, the activator quantity comprises at least 3.5% w/w of total concrete composition.

In one example, the filler quantity comprises the difference between the cement quantity (i.e. the original quantity of cement required by the standard mix) and the reduced cement quantity, minus the activator quantity. This provides a method for the skilled person to reduce the quantity of cement used in a concrete mix by replacing it with filler and activator.

In a further example, the method further comprises preparing a concrete mixture comprising the reduced cement quantity, the activator quantity and the filler quantity.

The one or more filler may be selected from the group consisting of SCMs, fly ash, slag, silica fume, metakaolin, rice husk ash, synthetic pozzolan, natural pozzolan, aggregate and/or sand.

In some examples, the invention provides a concrete composition comprising SCMs and an activator admixture. In some examples, up to 50% of cement is substituted with a binder which is a combination of activator plus natural or synthetic SCMs.

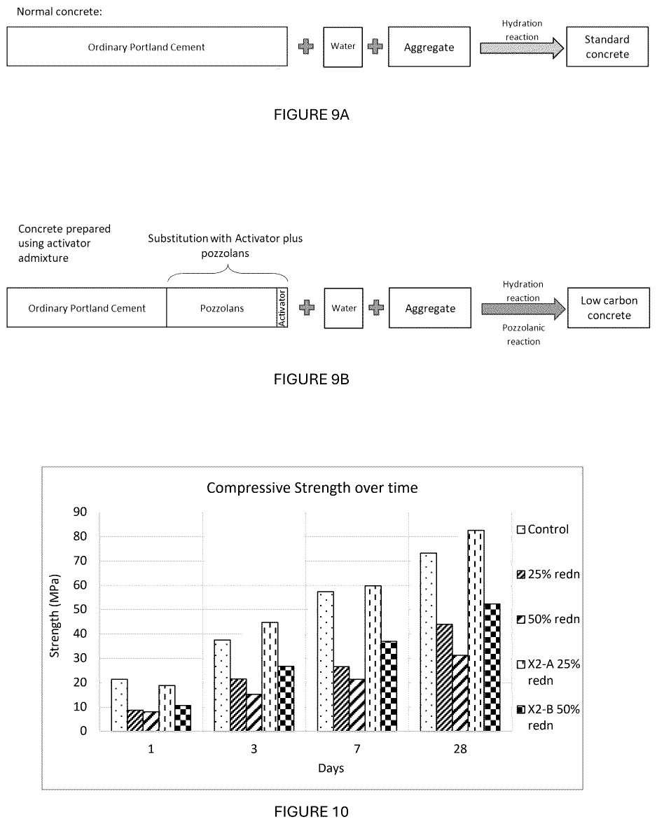

FIGS. 9A and 9B illustrate the invention showing the substitution of cement with a portion of SCMs plus activator. The proportions shown in these figures are exemplary and not to scale and not intended to limit the scope of the invention. Without wishing to be bound by theory, it is believed that when activator admixtures described herein are combined with pozzolanic SCMs and cement in the presence of water, the hydration and pozzolanic reactions synergise to produce more CSH and a high-performance hydraulic binder. This binder exhibits equivalent or greater strength and reduced porosity compared to standard concrete containing OPC. In particular, traditional pozzolanic mixtures exhibited slower strength development which made them less suitable for construction projects with tight timelines. The present invention provides admixtures that avoids this drawback by maximising the initial reactivity of the pozzolans to enable the true potential of pozzolanic concrete to be realised in a process that is energy-efficient and low in carbon emissions. This substitute binder has similar properties to cement but with significantly lower carbon emissions.

When the activator is combined with the SCMs, water and Ordinary Portland Cement, a series of reactions occur which augment the cement hydration reactions and create additional chemical bonds. This results in a similar strength gain and workability compared with OPC, and superior durability. In standard concrete (FIG. 9A), Ordinary Portland Cement (OPC) is combined with water and aggregate (sand or rocks). The OPC combines with water and undergoes the hydration reaction to form concrete. In 9B, the pozzolanic reaction is leveraged to provide a hybrid chemical process which combines the hydration reaction with the pozzolanic reaction. This hybrid reaction involves:
a. the cement hydration reaction to produce calcium hydroxide (Ca(OH)₂); and
b. the pozzolanic reactions in which the Ca(OH)₂ is hydrolysed and consumed in the pozzolanic reactions by reaction with SiO₂ and Al₂O₃ in the presence of water.
C. This reaction forms compounds possessing cementitious properties to augment the strength and durability of standard concrete.

When water is added to Ordinary Portland Cement it undergoes hydration, producing calcium silicate hydrate (C-S-H) and calcium hydroxide (Ca(OH)₂). Pozzolanic materials (SiO₂ and Al₂O₃) in the mix react with calcium hydroxide to form additional C-S-H, which is the primary binding phase in concrete, responsible for its strength and durability. Therefore the pozzolanic components of the reaction generate additional C-S-H, contributing to a denser and more robust microstructure. This additional C-S-H fills the voids and pores within the concrete, reducing its porosity and permeability. This less permeable material is more resistant to environmental factors such as freeze-thaw cycles, sulphate attack, alkali-silica reaction and the ingress of harmful substances. Example 3 illustrates this reduction in porosity and permeability and shows how the activator admixtures contribute to these beneficial effects.

In some examples, the invention provides a concrete composition comprising SCMs and an activator admixture. In some examples, up to 50% of cement is substituted with a binder which is a combination of activator plus natural or synthetic SCMs. For example 10% may be replaced which provide moderate levels of carbon emission reduction and may be appropriate for concrete compositions that require high cement content. In other examples, 20%, 25% or 30% cement substitution may be used with pozzolanic SCMs replacing the cement. These provide higher levels of cement substitution for enhanced carbon emission reduction. Activators of the invention are active to ensure that strength is not appreciably affected at these substitution levels. In other examples, higher levels of cement substitution may be achieved, for example 40, 50 or 60% substitution. At these levels there are substantial benefits in the reduction of carbon emissions but concrete strength may be negatively affected at very high substitution levels. For some applications, the strength is less important. Further, SCMs which already exhibit high surface activation (e.g. fly ash) may be used as a substitute for the cement, and, in tandem with activator admixtures of the invention, these high levels of substitution can still provide high strength concrete compositions.

Accordingly, in some examples, the invention provides a concrete composition comprising:
a. an activator admixture as described herein
b. cementitious material, and
c. aggregate.

The aggregate may comprise a coarse aggregate and a fine aggregate. The concrete composition may be designed to exhibit a compressive strength determined in accordance with NZS3112 part 2 at day 28 is greater than 20 MPa or 25 MPa. In some examples the concrete composition comprises cement and pozzolanic SCM filler wherein the pozzolanic SCM filler is present in an amount of 10 to 50% w/w of cementitious material, for example up to 10%, up to 20%, up to 25%, up to 30%, up to 40% or up to 50% SCM.

The entire disclosures of all applications, patents and publications cited above and below, if any, are herein incorporated by reference. Reference to any prior art in this specification is not, and should not be taken as, an acknowledgement or any form of suggestion that that prior art forms part of the common general knowledge in the field of endeavour in any country in the world.

Whilst it will be appreciated that various features of the embodiments may be combined, they may also be used independently of each other.

It should be noted that the above-mentioned examples illustrate rather than limit the disclosure, and that those skilled in the art will be able to design many alternative embodiments without departing from the scope of the appended claims.

### REFERENCES

Tikalsky, P. J., Huffman, M. V., & Barger, G. M. (2000). Use of Raw or Processed Natural Pozzolans in Concrete. American Concrete Institute, 1-24.

### EXAMPLES

The following examples illustrate embodiments of the invention. Examples in the past tense involve the manufacture and use of activators according to the invention and cement-activator blends that use such activators. Examples in the present tense are hypothetical in nature but illustrative of embodiments within the scope of the invention.

Throughout the examples, standardised test procedures were followed. Tests are carried out on concrete or mortar, either in the laboratory or in the field, to determine its properties. This information may then be used in a number of ways: to determine whether the concrete complies with the requirements of a specification; to forecast how it will perform in service; to determine the effect of different materials; or simply to determine whether some change is necessary in the mix proportions, e.g. the water content.

Concrete and mortar is required to have certain properties at two distinct stages: when it is still plastic and when it has hardened. The plastic-state properties determine the ease with which it can be placed and finished, the hardened state properties, how well it will perform in the completed structure. The methodology and relevance of these tests is described below:

### Sampling

It is essential that the test results are representative of the concrete being tested. Hence, it is essential that the test sample be representative of the concrete from which it is taken. NZ Standard 3112 sets out procedures for obtaining representative samples from freshly mixed concrete for either consistence (slump) tests or the moulding of specimens for other tests.

NZS 3104 imposes a number of requirements on the sampling of concrete. Where the sample is being taken to check the quality of the concrete being supplied to a project, it requires that samples be taken after completion of mixing but prior to site handling. Generally, this means that the concrete is sampled at the job site from the delivery truck, although sampling at the concrete plant after mixing is permitted.

There are two types of ‘sampling’ methods:
1. Snatch sample. In this case a single sample is taken from one position in the concrete.
2. Representative sample. In this case three or more samples are taken from different positions in the concrete and are then mixed together to form the single sample.

To ensure that samples are representative of the concrete being delivered to the site, they should be collected in a random manner, i.e. the batches of concrete or delivery units from which the individual samples are taken must be selected randomly, e.g. by using a list of random numbers to select batches. When a consistence or slump test only is to be performed, the test sample should be taken from the delivery or mixer truck immediately after the first 0.1 m³ of concrete has been discharged.

### Plastic-State Properties

When first mixed, concrete is normally plastic and workable, i.e. able to be placed in formwork and compacted with relative ease. The bulk of concrete delivered to construction sites is workable and cohesive without being fluid or over-wet. Both workability and cohesiveness are important characteristics of concrete in its plastic state. Workability, because it determines the ease with which the concrete can be placed and compacted; cohesiveness, because it determines the tendency of the components in the concrete to segregate one from the other during handling and placing. A concrete may be workable but lack cohesion resulting in segregation, honeycombing and similar defects.

The workability and cohesiveness of fresh concrete should suit the particular placing conditions and the compaction equipment available. Concrete with ‘low’ workability will normally require a large compactive effort to achieve maximum density, whilst ‘high’ workability concrete will be relatively easy to compact.

Mortar testing is preferred in some instances due to its simplified composition, offering greater consistency and control over variables compared to concrete. It isolates binder properties without the influence of coarse aggregates, facilitating more precise and reproducible results. Additionally, mortar allows for accelerated testing cycles and is ideal for studies focused on cementitious material behaviour.

Procedures used for the testing of plastic concrete have been standardised by Standards Australia and Standards New Zealand AS 1012 or NZS 3112 Part 1.

Test 1—Workability testing—The Slump Test

The slump test is fully described in Australian Testing standard AS 1012.3.1 and NZS 3112 Part 1 Section 5. The equipment required to conduct the test comprises a mould (the hollow frustum of a cone 200 mm in diameter at the bottom, 100 at the top, and 300 mm high) made of galvanised sheet metal and fitted with handles and foot-pieces; a steel tamping rod; a rule; and auxiliary equipment such as a scoop, a steel tray and a container in which to collect the sample to be tested. The test is conducted by first obtaining a representative sample of the concrete to be tested. The slump cone is filled with the concrete to be tested in three approximately equal volumes, each layer being rodded 25 times to compact it before the next layer is added. Surplus concrete is struck off the top of the cone which is then removed from the concrete by lifting it slowly and the concrete allowed to subside. The amount by which the top of the cone drops (from the initial 300 mm height) is measured and is known as the slump. If, in subsiding, the concrete cone shears or collapses, the test should be repeated using a fresh portion of the sample. If the concrete again shears or collapses, this fact should be recorded as it indicates a lack of cohesiveness in the mixture.

### Test 2—Compressive Strength

Concrete is a naturally strong material in compression, i.e. it can resist high crushing loads. It is relatively weak in tension, i.e. it cracks fairly readily if stretched or bent. It is therefore normally reinforced with steel when it is to be subjected to tension or bending. The compressive strength of concrete is a measure of its ability to resist loads which tend to crush it. When test specimens are fabricated, cured and crushed in accordance with NZS 3112 Part 2, any variation in their compressive strengths should reflect variations in the properties of the concretes, rather than the specimens or the test procedures. It is assessed by measuring the maximum resistance to crushing offered by a standard test specimen. Compression test specimens used for concrete testing were 100 mm diameter×200 mm high cylinders. Compression test specimens used for mortar testing were 50×50×50 mm cubes. The samples were tested in accordance with NZS3112 part 2.

Test 3—Particle size analysis

Dry samples were dispersed in water and analysed using a Malvern MasterSizer 3000 according to manufacturer's instructions.

Test 4—Chemical composition analysis

Dry samples were analysed for chemical composition using Borate fusion/X-ray fluorescence spectrometry according to manufacturer's instructions.

### Activator Development

In examples 1 and 2 below, concrete activators were tested with natural pozzolans of varying particle size.

### Example 1a

Aim—This experiment tested the effect of different chemical compositions for a given particle size distribution, i.e. similar median particle size Dv50, of a natural pozzolan-containing activator and a plasticiser on compressive strength (at day 1, 3, 7 and 28).

Methodology—Two sets of concrete mixes were prepared:
Control mix—20 MPa grade concrete.
2× Activator mix—20 MPa grade concrete, as control, but with Plasticiser fully replaced by the Activator described below at 3% of cementitious material. Water content is adjusted to achieve target slump on mixing of 180 mm (+−40 mm permissible tolerance on slump).

The following concrete compositions were mixed:

| Component | Control | Gamma | Omicron |
|---|---|---|---|
| Aggregate - 13 mm, kg/m3 | 450 | 450 | 450 |
| Aggregate - 10 mm, kg/m3 | 450 | 450 | 450 |
| Aggregate - Pap 7, kg/m3 | 604 | 604 | 604 |
| Sand, kg/m3 | 456 | 456 | 456 |
| Cement kg/m3 | 245 | 245 | 245 |
| Water SSD, kg/m3 | 181 | 185 | 149 |
| Activator, kg/m3 | | 7.35 | 7.35 |
| WR/Superplasticiser, L | 0.98 | | |
| Activator: Superplasticiser, | | 34.0 | 17.0 |
| % of weight | | | |
| NP particle size <90 μm, % | | 90.92 | 86.06 |
| NP particle size <40 μm, % | | 64.48 | 61.50 |
| NP particle size <15 μm, % | | 38.03 | 38.03 |
| NP particle size Dv(50) | | 24.2 μm | 25.1 μm |

The Activator concrete contained an activator of the invention described herein. The activator had the following chemical composition:

| | | | | Gamma | Omicron |
|---|---|---|---|---|---|
| | Chemical | | | Weight | Weight |
| Component | formula | CAS no. | EC no. | % | % |
| Silicon | SiO₂ | 7631-86-9 | 231-545-4 | 42.56 | 53.93 |
| dioxide | | | | | |
| Aluminium | Al₂O₃ | 1344-28-1 | 215-691-6 | 18.11 | 15.97 |
| oxide | | | | | |

Samples were prepared according to NZS 3112 Part 1 Section 5. Strength, chemical composition and particle size were tested according to the procedures described in the test protocols 1, 2 and 3 above.

### Results

| Variable | Control | Gamma | Omicron |
|---|---|---|---|
| Strength day 1, Mpa | 5 | 4 | 10 |
| Strength day 3, Mpa | 11 | 13 | 20 |
| Strength day 7, Mpa | 17 | 20 | 27 |
| Strength day 28, Mpa | 24 | 26 | 32 |

See figures:

FIG. 1.a.i—Comparison of strength over time for activator versus control concrete.

FIG. 1.a.ii—Particle size and volume density of particles for activator gamma.

TABLE 1
showing particle size and % volume under for activator gamma.

| Size | % Volume |
|---|---|
| (μm) | Under |
| 0.05 | 0 |
| 0.06 | 0 |
| 0.12 | 0 |
| 0.24 | 0 |
| 0.49 | 0.42 |
| 0.98 | 7.23 |
| 2 | 11.06 |
| 3.9 | 17.03 |
| 7.8 | 25.17 |
| 15.6 | 38.03 |
| 31 | 58.26 |
| 37 | 64.48 |
| 44 | 70.6 |
| 53 | 76.93 |
| 63 | 82.31 |
| 74 | 86.8 |
| 88 | 90.92 |
| 105 | 94.32 |
| 125 | 96.95 |
| 149 | 98.72 |
| 177 | 99.7 |
| 210 | 99.99 |
| 250 | 100 |
| 300 | 100 |

FIG. 1.a.iii—Particle size and volume density of particles for activator Omicron.

TABLE 2
showing particle size and % volume under for activator Omicron.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.1 |
| 0.98 | 4.41 |
| 2 | 7.94 |
| 3.9 | 14.44 |
| 7.8 | 24.36 |
| 15.6 | 38.03 |
| 31 | 56.11 |
| 37 | 61.5 |
| 44 | 66.89 |
| 53 | 72.63 |
| 63 | 77.69 |
| 74 | 82.02 |
| 88 | 86.06 |
| 105 | 89.4 |
| 125 | 92 |
| 149 | 93.89 |
| 177 | 95.25 |
| 210 | 96.3 |
| 250 | 97.21 |
| 300 | 98.1 |
| 350 | 98.79 |
| 420 | 99.43 |
| 500 | 99.83 |
| 590 | 100 |
| 710 | 100 |
| 840 | 100 |
| 1000 | 100 |
| 1190 | 100 |

### Conclusions

1. Replacement of standard plasticiser with an activator improved compressive strength at each day of strength setting.
2. Activator omicron exhibited increased compressive strength compared to control and gamma activator at each day of strength setting. This indicates that the increase in Silicon Dioxide improves strength.
3. Activator omicron exhibited increased compressive strength compared to control and gamma activator at each day of strength setting. This further indicates the increase in overall sum of Silicon Dioxide and Aluminium Oxide improves strength.

Based on these experiments, further testing was carried out to test different median particle sizes for a given chemical composition of the activator.

### Example 1b

Aim—This experiment tested the effect of different particle size medians Dv50 of a natural pozzolan-containing activator, for a given chemical composition and plasticiser level, on strength (at day 1, 3, 7 and 28). The experiment also tested the impact of the pozzolan-containing activator on slump retention.

Methodology—Two sets of concrete mixes were prepared:
Control mix—25 Mpa grade concrete. Standard aggregates composition. The coarse and fine aggregate amounts are determined according to a standard but proprietary composition by a third party. The amount of these components can vary and a skilled person in the art would be able to readily determine suitable components and mass required.
2× Activator mix—25 Mpa grade concrete, as control, with Plasticiser fully replaced by the Activator described below at 3% of total cementitious material by weight and sand volume slightly adjusted to maintain density of the control mix. Water content is adjusted to achieve target slump on mixing of 180 mm (+−40 mm permissible tolerance on slump). Aggregate content was same as control.

The following concrete compositions were mixed:

| Component | Control | Tau | Omega2 |
|---|---|---|---|
| Cement kg/m3 | 275 | 275 | 275 |
| Water SSD, kg/m3 | 178 | 150 | 147 |
| Activator, kg/m3 | | 8.3 | 8.3 |
| Water reducer/Superplasticiser, | 1.65 | | |
| L | | | |
| Activator: Superplasticiser, % | | 19.00 | 19.00 |
| of weight | | | |
| NP particle size <90 μm, % | | 80.39 | 78.47 |
| NP particle size <40 μm, % | | 59.39 | 54.68 |
| NP particle size <15 μm, % | | 36.51 | 33.87 |
| NP particle size Dv(50) | | 26.3 μm | 31.1 μm |

The Activator concrete contained an activator of the invention described herein. The activator had the following chemical composition:

| | | | | Tau | Omega2 |
|---|---|---|---|---|---|
| | Chemical | | | Weight | Weight |
| Component | formula | CAS no. | EC no. | % | % |
| Silicon dioxide | SiO₂ | 7631-86-9 | 231-545-4 | 54.75 | 53.94 |
| Aluminium oxide | Al₂O₃ | 1344-28-1 | 215-691-6 | 14.68 | 12.54 |

Samples were obtained from freshly mixed concrete, in accordance with NZS 3112, using Snatch Sample method, and slump loss was measured over time in 30 mins increments, according to NZS 3112 Part 1 Section 5. Slump (workability), strength and particle size were tested according to the procedures described in Test 1, 2 and 3 above.

### Results

| Variable | Control | Tau | Omega2 |
|---|---|---|---|
| Slump - 0 mins, mm | 140 | 200 | 220 |
| Slump - 30 mins, mm | 60 | 200 | 220 |
| Strength day 1, Mpa | 5 | 8 | 10 |
| Strength day 3, Mpa | 15 | 26 | 28 |
| Strength day 7, Mpa | 22 | 38 | 36 |
| Strength day 28, Mpa | 31 | 53 | 55 |

See figures:

FIG. 1.b.i—Slump loss of concrete over time for control and activator-containing concrete.

FIG. 1.b.ii—Comparison of strength over time for activator versus control concrete showing that the activators produced concrete with higher compressive strength at all time points. Data for day 28 still to come.

FIG. 1.b.iii—Particle size and volume density of particles for activator Tau.

FIG. 1.b.iv—Particle size and volume density of particles for activator Omega2.

TABLE
showing particle size and % volume under for activator Tau.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.07 |
| 0.98 | 3.81 |
| 2 | 7 |
| 3.9 | 12.96 |
| 7.8 | 22.56 |
| 15.6 | 36.51 |
| 31 | 54.51 |
| 37 | 59.39 |
| 44 | 64.07 |
| 53 | 68.89 |
| 63 | 73.1 |
| 74 | 76.76 |
| 88 | 80.39 |
| 105 | 83.73 |
| 125 | 86.68 |
| 149 | 89.28 |
| 177 | 91.5 |
| 210 | 93.44 |
| 250 | 95.18 |
| 300 | 96.79 |
| 350 | 97.95 |
| 420 | 98.99 |
| 500 | 99.63 |
| 590 | 99.93 |
| 710 | 100 |
| 840 | 100 |
| 1000 | 100 |
| 1190 | 100 |

TABLE
showing particle size and % volume under for activator Omega2.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.05 |
| 0.98 | 2.96 |
| 2 | 6.01 |
| 3.9 | 11.85 |
| 7.8 | 21.21 |
| 15.6 | 33.87 |
| 31 | 49.93 |
| 37 | 54.68 |
| 44 | 59.51 |
| 53 | 64.79 |
| 63 | 69.66 |
| 74 | 74.05 |
| 88 | 78.47 |
| 105 | 82.51 |
| 125 | 86.02 |
| 149 | 88.96 |
| 177 | 91.38 |
| 210 | 93.41 |
| 250 | 95.16 |
| 300 | 96.74 |
| 350 | 97.88 |
| 420 | 98.9 |
| 500 | 99.56 |
| 590 | 99.9 |
| 710 | 100 |
| 840 | 100 |
| 1000 | 100 |
| 1190 | 100 |

### Conclusions

1. Both activator-containing concretes show significant strength gains as compared to control concrete. This indicates that within the indicated median particle size range Dv(50)<40 μm, the activator is effective in increasing compressive strength at Dv(50)=26.3 μm and Dv(50)=31.1 μm for a given chemical composition.
2. Activator Omega2 had increase median particle size, and increase of particle size in each of the defined ranges (which is indicated by decrease % of particles that fall within the specified range). This slightly increased early strength gains (for day 1 and day 3) as compared with the activator tau with a smaller median size. This is of particular interest, because usually strength is increased with decrease in particle size of the pozzolans.
3. Both activator-containing concretes shown significant improvement in slump retention as compared to control concrete. This indicates that the activator is effective in increasing slump retention as well as increasing compressive strength.

### Example 1c

Aim—This experiment tested the effect of activator containing natural pozzolans on workability (slump) and compressive strength (at day 1,3,7,28) of concrete using Portland cement only as a binder. The aim was to increase the grade of concrete, without increasing cement content. Alternatively, the aim is to test the ability of natural-pozzolans containing activator to reduce cement content in concrete without affecting its workability and strength.

Methodology—Three sets of concrete mixes were prepared:
Control mix 1-25 MPa grade concrete. Standard aggregates composition. The coarse and fine aggregate amounts are determined according to a standard but proprietary composition by a third party. The amount of these components can vary and a skilled person in the art would be able to readily determine suitable components and mass required.
Control mix 2-40 MPa grade concrete. Standard aggregates composition. The coarse and fine aggregate amounts are determined according to a standard but proprietary composition by a third party. The amount of these components can vary and a skilled person in the art would be able to readily determine suitable components and mass required.
1× Activator mix—25 MPa grade concrete, as control, but with Plasticiser fully replaced by the Activator described below at 3% of cementitious material. Water content is adjusted to achieve target slump on mixing of 180 mm (+−40 mm permissible tolerance on slump). Sand and aggregates as per Control 1.

The following concrete compositions were mixed:

| Component | Control 1 | Control 2 | Pi |
|---|---|---|---|
| Cement kg/m3 | 275 | 386 | 275 |
| Water SSD, kg/m3 | 178 | 156 | 119 |
| Activator, kg/m3 | | | 8.3 |
| WR/Superplasticiser, L | 1.65 | 2.3 | |
| Activator: Superplasticiser, % of weight | | | 22.0 |
| NP particle size <90 μm, % | | | 84.44 |
| NP particle size <40 μm, % | | | 59.26 |
| NP particle size <15 μm, % | | | 35.59 |
| NP particle size Dv50 | | | 27.3 μm |

The Activator concrete contained an activator of the invention described herein. The activator had the following chemical composition:

| | Chemical | | | Pi Weight |
|---|---|---|---|---|
| Component | formula | CAS no. | EC no. | % |
| Silicon dioxide | SiO₂ | 7631-86-9 | 231-545-4 | 51.12 |
| Aluminium oxide | Al₂O₃ | 1344-28-1 | 215-691-6 | 15.07 |

Samples were obtained from freshly mixed concrete, in accordance with NZS 3112, using Snatch Sample method, and slump loss was measured over time in 30 mins increments, according to NZS 3112 Part 1 Section 5. Slump (workability), strength and particle size were tested according to the procedures described in Test 1, 2 and 3 above.

### Results

| Variable | Control 1 | Control 2 | Pi |
|---|---|---|---|
| Slump - 0 mins, mm | 140 | 180 | 190 |
| Slump - 30 mins, mm | 60 | 180 | 150 |
| Slump - 60 mins, mm | 0 | 150 | 140 |
| Strength day 1, Mpa | 5 | 9 | 12 |
| Strength day 3, MPa | 15 | 26 | 25 |
| Strength day 7, MPa | 22 | 35 | 36 |
| Strength day 28, MPa | 31 | 46 | 45 |

See figures:

FIG. 1.c.i—Slump loss of concrete over time showing that workability of control 2 and activator retained workability to a similar extent.

FIG. 1.c.ii—Comparison of strength over time for 25 MPa concrete, 40 MPa concrete, and activator-containing concrete using 25 MPa concrete's cement volume with strength at 1, 3, 7 and 28 days post-pour.

FIG. 1.c.iii—Particle size and volume density of particles for activator Pi.

TABLE
showing particle size and % volume under for activator Pi.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.08 |
| 0.98 | 3.98 |
| 2 | 7.2 |
| 3.9 | 13.17 |
| 7.8 | 22.39 |
| 15.6 | 35.59 |
| 31 | 53.79 |
| 37 | 59.26 |
| 44 | 64.74 |
| 53 | 70.59 |
| 63 | 75.77 |
| 74 | 80.23 |
| 88 | 84.44 |
| 105 | 87.99 |
| 125 | 90.81 |
| 149 | 92.92 |
| 177 | 94.48 |
| 210 | 95.71 |
| 250 | 96.74 |
| 300 | 97.73 |
| 350 | 98.48 |
| 420 | 99.19 |
| 500 | 99.67 |
| 590 | 99.92 |
| 710 | 100 |
| 840 | 100 |
| 1000 | 100 |
| 1190 | 100 |

### Conclusions

1. Adding the activator (Pi) at 3% of cementitious material (while removing the plasticiser) to a 25 MPa concrete increased the workability and strength of concrete at each age of strength setting.
2. Adding the activator at 3% of cementitious material (while removing the plasticiser) increased the grade of concrete from 25 MPa to 40 MPa. The cement-content in control 1 mix achieved a 25 MPa concrete. The activator-containing mix with cement at the same level as control 1 (25 MPa) presents similar strength to 40 MPa concrete. This means that pozzolanic activator with optimised particle size distribution can increase the grade of concrete by more than 1 grade without increasing cement content of the mix. Specifically, 40 MPa concrete performance can be achieved with 29% less cement content, when activator is used at 3% of the resulting cementitious material, without negatively affecting strength and workability of concrete.
3. Activator-containing concrete also used substantially less water when compared to both 25 MPa and 40 MPa control mixes with 33% and 24% less water used respectively.

Based on these experiments, further tests were carried out to understand the cement reduction that can be achieved for a given grade of concrete, using the activator and natural pozzolanic SCMs.

### Example 2a

Aim—This experiment tested the ability and the extent of a natural pozzolan-containing activator to activate natural pozzolanic SCMs to act like a cement binder. The aim is to replace cement with natural pozzolanic SCMs without detrimental impacts on strength and workability.

### Methodology

Two sets of concrete mixes were prepared:
Control mix 1-25 MPa grade concrete. The coarse and fine aggregate are prepared according to a proprietary composition by a third party. The amount of these components can vary and a skilled person in the art would be able to readily determine suitable components and mass required.
7× Activator mix-25 MPa grade concrete, as control, but with Plasticiser fully replaced by the Activator described below at 3-4% of cementitious material. Cement is replaced with natural pozzolans at levels between 0%-40%. Water content is adjusted to achieve target slump on mixing of 180 mm (+−40 mm permissible tolerance on slump). Sand and aggregates as per the control.

The following concrete compositions were mixed:

| | | Pi | Pi - | Pi - | Pi - | Tau - | Tau - | Tau - |
|---|---|---|---|---|---|---|---|---|
| Component | Control | 0% | 15% | 20% | 25% | 30% | 35% | 40% |
| Cement kg/m3 | 275 | 275 | 234 | 220 | 206 | 193 | 179 | 164 |
| Water SSD, | 178 | 119 | 120 | 124 | 111 | 118 | 109 | 101 |
| kg/m3 | | | | | | | | |
| Activator, kg/m3 | | 8.3 | 8.3 | 8.3 | 8.3 | 8.3 | 8.3 | 11.0 |
| Superplasticiser, | 1.65 | | | | | | | |
| L | | | | | | | | |
| Pozzolanic | | | 41 | 55 | 69 | 83 | 100 | 112 |
| SCMs, kg/m3 | | | | | | | | |
| Activator: | | 22.00 | 22.00 | 22.00 | 22.00 | 19.00 | 19.00 | 19.00 |
| Superplasticiser, | | | | | | | | |
| % of weight | | | | | | | | |
| NP particle | | 84.44 | 84.44 | 84.44 | 84.44 | 80.39 | 80.39 | 80.39 |
| size <90 μm, % | | | | | | | | |
| NP particle | | 59.26 | 59.26 | 59.26 | 59.26 | 59.39 | 59.39 | 59.39 |
| size <40 μm, % | | | | | | | | |
| NP particle | | 35.59 | 35.59 | 35.59 | 35.59 | 36.51 | 36.51 | 36.51 |
| size <15 μm, % | | | | | | | | |
| NP particle size | | 27.3 | 27.3 | 27.3 | 27.3 | 26.3 | 26.3 | 26.3 |
| Dv(50), μm | | | | | | | | |

The Activator concrete contained an activator of the invention described herein. The activator had the following chemical composition:

| | | | | Pi | Tau |
|---|---|---|---|---|---|
| | Chemical | | | Weight | Weight |
| Component | formula | CAS no. | EC no. | % | % |
| Silicon dioxide | SiO₂ | 7631-86-9 | 231-545-4 | 51.12 | 54.75 |
| Aluminium oxide | Al₂O₃ | 1344-28-1 | 215-691-6 | 15.07 | 14.68 |

Samples were obtained from freshly mixed concrete, in accordance with NZS 3112, using Snatch Sample method, and slump loss was measured over time in 30 mins increments, according to NZS 3112 Part 1 Section 5. Slump (workability), strength and particle size were tested according to the procedures described in Test 1, 2 and 3 above.

### Results

| Variable | Control | 0% | −15% | −20% | −25% | −30% | −35% | −40% |
|---|---|---|---|---|---|---|---|---|
| Slump - 0 mins, mm | 140 | 190 | 180 | 180 | 200 | 210 | 190 | 210 |
| Slump - 30 mins, mm | 60 | 150 | 150 | 170 | 180 | 180 | 170 | 220 |
| Slump - 60 mins, mm | | 140 | 30 | 170 | 150 | 110 | 60 | 210 |
| Slump - 90 mins, mm | | | | 50 | | | | 160 |
| Strength day 1, Mpa | 5 | 12 | 12 | 11 | 6 | 6 | 6 | 5 |
| Strength day 3, Mpa | 15 | 28 | 26 | 23 | 15 | 18 | 17 | 14 |
| Strength day 7, Mpa | 22 | 36 | 33 | 28 | 23 | 27 | 26 | 21 |
| Strength day 28, Mpa | 31 | 45 | 40 | 39 | 30 | 39 | 36 | 39 |

See figures;

FIG. 2.a.i—Slump loss of concrete over time showing good workability for all activator-containing concrete mixtures.

FIG. 2.a.ii—Comparison of strength over time for activator versus control concrete showing that activator-containing concrete at all cement-reduction levels had compressive strength substantially equal to or greater than control at 1, 3, 7 and 28 days post-pour.

FIG. 2.a.iii—Particle size and volume density of particles for activator Pi.

FIG. 2.a.iv—Particle size and volume density of particles for activator Tau.

TABLE
showing particle size and % volume under for activator Pi.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.08 |
| 0.98 | 3.98 |
| 2 | 7.2 |
| 3.9 | 13.17 |
| 7.8 | 22.39 |
| 15.6 | 35.59 |
| 31 | 53.79 |
| 37 | 59.26 |
| 44 | 64.74 |
| 53 | 70.59 |
| 63 | 75.77 |
| 74 | 80.23 |
| 88 | 84.44 |
| 105 | 87.99 |
| 125 | 90.81 |
| 149 | 92.92 |
| 177 | 94.48 |
| 210 | 95.71 |
| 250 | 96.74 |
| 300 | 97.73 |
| 350 | 98.48 |
| 420 | 99.19 |
| 500 | 99.67 |
| 590 | 99.92 |
| 710 | 100 |
| 840 | 100 |
| 1000 | 100 |
| 1190 | 100 |

TABLE
showing particle size and % volume under for activator Tau.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.07 |
| 0.98 | 3.81 |
| 2 | 7 |
| 3.9 | 12.96 |
| 7.8 | 22.56 |
| 15.6 | 36.51 |
| 31 | 54.51 |
| 37 | 59.39 |
| 44 | 64.07 |
| 53 | 68.89 |
| 63 | 73.1 |
| 74 | 76.76 |
| 88 | 80.39 |
| 105 | 83.73 |
| 125 | 86.68 |
| 149 | 89.28 |
| 177 | 91.5 |
| 210 | 93.44 |
| 250 | 95.18 |
| 300 | 96.79 |
| 350 | 97.95 |
| 420 | 98.99 |
| 500 | 99.63 |
| 590 | 99.93 |
| 710 | 100 |
| 840 | 100 |
| 1000 | 100 |
| 1190 | 100 |

### Conclusions

1. With natural pozzolans-containing activator it is possible to replace cement with natural pozzolanic SCMs without loss to workability and strength at timepoint.
2. Activators enabled cement replacement with natural pozzolans at up to and including 40%.
3. At higher cement replacement levels, higher dosage of activator might be used, i.e. increase from 3% for up to 35% replacement levels to 4% for 40% replacement levels.
4. With increase of the activator dosage, the workability and slump retention further increase.
5. Further cement replacement levels are possible with tailoring the activator chemical composition. For example, at 30% reduction levels the activator was tailored to achieve higher strength by increasing the proportion of Silicon Dioxide in the activator, which achieved higher strength even at reduced plasticiser levels (as discovered with previous testing).

### Example 2b

Aim—This experiment tested the ability and the extent of a natural pozzolan-containing activator to activate synthetic pozzolanic SCMs (Slag) to act like a cement binder. The aim is to replace cement with synthetic SCMs without detrimental impacts on strength and workability.

### Methodology

Three concrete mixes were prepared:
Control mix 1-40 Mpa grade concrete. The coarse and fine aggregate are prepared according to a proprietary composition by a third party. The amount of these components can vary and a skilled person in the art would be able to readily determine suitable components and mass required.
Control mix 2-40 Mpa grade concrete, with 50% of cement replaced by synthetic pozzolanic SCMs-Slag. The coarse and fine aggregate are prepared according to a proprietary composition by a third party. The amount of these components can vary and a skilled person in the art would be able to readily determine suitable components and mass required.
1× Activator mix—40 Mpa grade concrete, as control, but with Plasticiser fully replaced by the Activator described below at 3.5% of cementitious material. Water content is adjusted to achieve target slump on mixing of 180 mm (+−40 mm permissible tolerance on slump). Sand and aggregates as per control.

The following concrete compositions were mixed:

| Component | Control | Control −50% | Tau −50% |
|---|---|---|---|
| Cement kg/m3 | 400 | 200 | 200 |
| Synthetic Pozzolanic SCMs - Slag | | 200 | 200 |
| kg/m3 | | | |
| Water SSD, kg/m3 | 200 | 120 | 120 |
| Activator, kg/m3 | | | 14.0 |
| Activator: Superplasticiser, % of | | | 19.00 |
| weight | | | |
| NP particle size <90 μm, % | | | 80.39 |
| NP particle size <40 μm, % | | | 59.39 |
| NP particle size <15 μm, % | | | 36.51 |
| NP particle size Dv(50) | | | 26.3 μm |

The Activator concrete contained an activator of the invention described herein. The activator had the following chemical composition:

| | Chemical | | | Tau Weight |
|---|---|---|---|---|
| Component | formula | CAS no. | EC no. | % |
| Silicon dioxide | SiO₂ | 7631-86-9 | 231-545-4 | 54.75 |
| Aluminium oxide | Al₂O₃ | 1344-28-1 | 215-691-6 | 14.68 |

Samples were obtained from freshly mixed concrete, in accordance with NZS 3112, using Snatch Sample method, and slump loss was measured over time in 30 mins increments, according to NZS 3112 Part 1 Section 5. Slump (workability), strength and particle size were tested according to the procedures described in Test 1, 2 and 3 above.

### Results

| Variable | Control | Control −50% | −50% |
|---|---|---|---|
| Slump - 0 mins, mm | 185 | 185 | 245 |
| Slump - 30 mins, mm | 160 | 80 | 200 |
| Slump - 60 mins, mm | 135 | 70 | 185 |
| Strength day 1, Mpa | 13.5 | 6.8 | 24.3 |
| Strength day 3, MPa | 34.0 | 21.0 | 45.5 |
| Strength day 7, MPa | 47.8 | 34.3 | 66.3 |
| Strength day 28, MPa | 57.8 | 51.0 | 76.0 |

TABLE
showing particle size and % volume under for activator Tau.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.07 |
| 0.98 | 3.81 |
| 2 | 7 |
| 3.9 | 12.96 |
| 7.8 | 22.56 |
| 15.6 | 36.51 |
| 31 | 54.51 |
| 37 | 59.39 |
| 44 | 64.07 |
| 53 | 68.89 |
| 63 | 73.1 |
| 74 | 76.76 |
| 88 | 80.39 |
| 105 | 83.73 |
| 125 | 86.68 |
| 149 | 89.28 |
| 177 | 91.5 |
| 210 | 93.44 |
| 250 | 95.18 |
| 300 | 96.79 |
| 350 | 97.95 |
| 420 | 98.99 |
| 500 | 99.63 |
| 590 | 99.93 |
| 710 | 100 |
| 840 | 100 |
| 1000 | 100 |
| 1190 | 100 |

### See Figures;

FIG. 2.b.i—Slump loss of activator-containing concrete over time showing significant improvement in workability vs. both controls.

FIG. 2.b.ii—Comparison of strength over time for activator versus control concrete showing that activator-containing concrete with 50% less cement produced compressive strength greater than controls 1 and 2 at all tested ages-1, 3, 7 and 28 days post-pour.

FIG. 2.b.iii—Particle size and volume density of particles for activator Tau.

### Conclusions

1. Concrete samples made from natural pozzolan-containing activator maintained workability and strength when 50% of the cement in a standard mix was replaced with synthetic pozzolanic SCMs.
2. Strength and workability were significantly higher for the Activator enhanced mix vs both control mixes which respectively comprised:
   a. no cement reduction; and
   b. similar cement reduction.
3. Activator-containing concrete enables the replacement of cement with synthetic pozzolans at over 50% replacement. This indicates that the pozzolanic activators of the invention enhance the binding activity of synthetic pozzolans at a higher efficiency than the enhancement of binding activity of natural pozzolans.
4. At higher cement replacement levels, higher dosage of activator can be used, for example 3.5% for 50% replacement levels.
5. With increase of the activator dosage, the workability and slump retention further increase.
6. Based on the data, it is expected that higher cement replacement percentage is possible e.g. 60% or 70% while maintaining equal or greater strength compared to cement-containing control samples. This is predictable based on the significant strength surplus was observed at each age of strength setting.
7. The natural-pozzolans containing activator can activate both natural and synthetic pozzolans to become an effective binder similar or better in properties to cement.

### Example 2c

Aim—This experiment tested the ability and the extent of a natural pozzolan-containing activator to activate natural pozzolanic SCMs to act like a cement binder.

Two sets of concrete mixes were prepared:
Control mix 1-35 MPa grade concrete. The coarse and fine aggregate are prepared according to a proprietary composition by a third party. The amount of these components can vary and a skilled person in the art would be able to readily determine suitable components and mass required.
KNP mix—35 MPa grade concrete, as control, but with an added mid-range plasticiser and 20% of cement replaced by KNP activated natural pozzolans. Water content is adjusted to achieve target slump on mixing of 60 mm (+−20 mm permissible tolerance on slump). Sand and aggregates as per the control.
Control mix 2-25 MPa grade concrete. The coarse and fine aggregate are prepared according to a proprietary composition by a third party. The amount of these components can vary and a skilled person in the art would be able to readily determine suitable components and mass required.
Activator mix-25 MPa grade concrete, as control, but with Plasticiser fully replaced by the Activator described below at 3-4% of cementitious material. 20% cement is replaced with natural pozzolans. Water content is adjusted to achieve target slump on mixing of 180 mm (+−40 mm permissible tolerance on slump). Sand and aggregates as per the control.

The following concrete compositions were mixed:

| | Control | −20% | Control | |
|---|---|---|---|---|
| Component | 1 | KNP | 2 | Pi −20% |
| Cement kg/m3 | 326 | 261 | 275 | 220 |
| Water SSD, kg/m3 | 196 | 196 | 178 | 124 |
| Activator, kg/m3 | | | | 8.3 |
| Superplasticiser, L | | 3.8 | 1.65 | |
| Pozzolanic SCMs, kg/m3 | | | | 55 |
| Activator: Superplasticiser, % of | | | | 22.00 |
| weight | | | | |
| NP particle size <90 μm, % | | | | 84.44 |
| NP particle size <40 μm, % | | | | 59.26 |
| NP particle size <15 μm, % | | | | 35.59 |
| NP particle size Dv(50), μm | | | | 27.3 μm |

The Activator concrete contained an activator of the invention described herein. The activator had the following chemical composition:

| | Chemical | | | Pi Weight |
|---|---|---|---|---|
| Component | formula | CAS no. | EC no. | % |
| Silicon dioxide | SiO₂ | 7631-86-9 | 231-545-4 | 51.12 |
| Aluminium oxide | Al₂O₃ | 1344-28-1 | 215-691-6 | 15.07 |

Samples were obtained from freshly mixed concrete, in accordance with NZS 3112, using Snatch Sample method, and slump loss was measured over time in 30 mins increments, according to NZS 3112 Part 1 Section 5. Slump (workability), strength and particle size were tested according to the procedures described in Test 1, 2 and 3 above.

### Results

| | | −15% | | |
|---|---|---|---|---|
| Variable | Control1 | KNP | Control2 | −20% |
| Strength day 7, Mpa | 30 | 27 | 22 | 28 |
| Strength day 28, Mpa | 42 | 41 | 31 | 39 |

TABLE
showing particle size and % volume under for activator Pi.

| | % |
|---|---|
| Size | Volume |
| (μm) | Under |
| 0.05 | 0 |
| 0.06 | 0 |
| 0.12 | 0 |
| 0.24 | 0 |
| 0.49 | 0.08 |
| 0.98 | 3.98 |
| 2 | 7.2 |
| 3.9 | 13.17 |
| 7.8 | 22.39 |
| 15.6 | 35.59 |
| 31 | 53.79 |
| 37 | 59.26 |
| 44 | 64.74 |
| 53 | 70.59 |
| 63 | 75.77 |
| 74 | 80.23 |
| 88 | 84.44 |
| 105 | 87.99 |
| 125 | 90.81 |
| 149 | 92.92 |
| 177 | 94.48 |
| 210 | 95.71 |
| 250 | 96.74 |
| 300 | 97.73 |
| 350 | 98.48 |
| 420 | 99.19 |
| 500 | 99.67 |
| 590 | 99.92 |
| 710 | 100 |
| 840 | 100 |
| 1000 | 100 |
| 1190 | 100 |

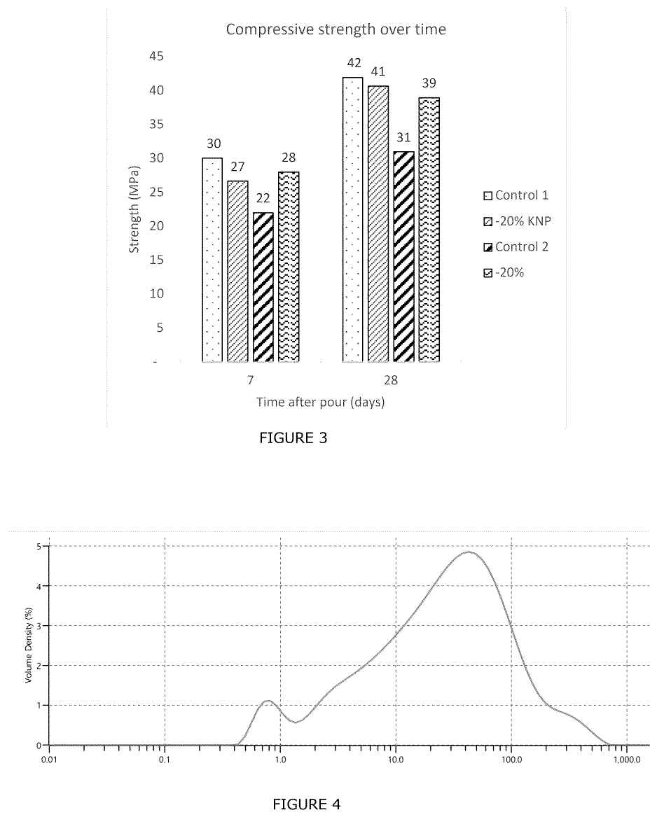

FIG. 3—Comparison of strength over time for KNP activated natural pozzolans vs control and Activator activated pozzolans vs. control, both at 20% cement replacement levels.

FIG. 4—Particle size and volume density of particles for activator Pi.

### Conclusions

1. KNP Activated natural pozzolans achieved slightly lower strength than control concrete at 20% cement replacement levels.
2. Natural pozzolans at 20% cement replacement levels activated by the activator, achieved at least 25% increase in strength at each tested age of strength setting as compared to control.
3. This indicates that activator is more effective at activating the natural pozzolans in achieving compressive strength that the KNP patented technology to activate natural pozzolans.
4. Further cement replacement levels with natural pozzolans are possible of up to 40%, with the activator, as presented in example 2a, and for 50% and above for industrial pozzolans.

### Example 3—carbon emission reduction through use of activators of the invention

Activators of the invention provide the ability to reduce the carbon emissions associated with preparation of a volume of concrete. This example illustrates the carbon emission reductions associated with the concrete mix ratios described in example 2c when applied to a larger scale concrete preparation project-two concrete mixes comprising activator of the invention versus a control mix.
Volume of concrete to be used in the project—100 m³
Grade of concrete—25 MPa

Three concrete mixes prepared:
Control mix—25 MPa grade concrete.
2× Activator mix-25 MPa grade concrete, as control, but with Plasticiser fully replaced by the Activator described below at 3% of cementitious material and 30% and 40% cement replaced by NZ natural pozzolan (pumice).

The following concrete compositions were mixed:

| Component | Control | Tau −30% | Tau −40% |
|---|---|---|---|
| Aggregate - 13 mm, kg/m3 | 450 | 450 | 450 |
| Aggregate - 10 mm, kg/m3 | 450 | 450 | 450 |
| Sand, kg/m3 | 1060 | 1112 | 1126 |
| Cement kg/m3 | 275 | 193 | 164 |
| Water SSD, kg/m3 | 178 | 118 | 101 |
| NZ Natural pozzolan, kg/m3 | | 83 | 112 |
| Activator, kg/m3 | | 8.3 | 11.0 |
| WR/Superplasticiser, L | 1.65 | | |
| Activator: Superplasticiser, % of | | 19.00 | 19.00 |
| weight of activator | | | |
| NP particle size <90 μm, % | | 80.39 | 80.39 |
| NP particle size <40 μm, % | | 59.39 | 59.39 |
| NP particle size <15 μm, % | | 36.51 | 36.51 |
| NP particle size Dv(50) | | 26.3 μm | 26.3 μm |

The Activator concrete contained an activator of the invention described herein. The activator had the following chemical composition:

| | Chemical | | | Tau Weight |
|---|---|---|---|---|
| Component | formula | CAS no. | EC no. | % |
| Silicon dioxide | SiO₂ | 7631-86-9 | 231-545-4 | 54.75 |
| Aluminium oxide | Al₂O₃ | 1344-28-1 | 215-691-6 | 14.68 |

### Results

The embodied carbon emissions of each mix were estimated using Neocrete eCalculator, a tool developed by an independent LCA assessor-Edge Environment to estimate the embodied carbon emissions per m³ of concrete in NZ, using average NZ data for embodied carbon for each of the materials used.

Life cycle assessment (LCA) per m³ of the ready mix concrete in New Zealand

| Green Star Impact Category | Control | Tau - 30% | Tau - 40% |
|---|---|---|---|
| Global warming potential, kg | 258 | 205 | 186 |
| CO2 eq./m³ | | | |
| Global warming potential, total | 25,800 | 20,500 | 18,600 |
| per project (100 m³) | | | |
| eCO² reduction to control, kg | — | 5,300 | 7,200 |
| eCO² reduction to control, % | — | 21% | 28% |

### Conclusions

Concrete containing activator with cement replacement with NZ natural pozzolans at 30% and 40% has less embodied carbon than control, by 21% and 28%, respectively.

### Example 4—Analysis of permeability of activator-containing concrete Aim

This experiment tested the special durability characteristics of concrete with significant cement reduction levels, partly replacement by natural pozzolans and containing the activator.

### Methodology

Concrete with cement replaced by an activator of the invention was analysed for special durability characteristics:
water permeability BS EN 12390-8:2019 “Depth of penetration of water under pressure”
water absorption AS 1012.12
water sorptivity ASTM C1585
Rapid chloride penetration

Sample cores of concrete were prepared and allowed to set for 28-56 days.

| | Control | Control | 30% cement | 30% cement |
|---|---|---|---|---|
| | 1 | 2 | reduction | reduction |
| Sample # | 392 | 390 | 391 | 389 |
| Cement, kg/m³ | 385 | 385 | 270 | 270 |
| Cement, % of control | 100% | 100% | 70% | 70% |
| Pozzolans, kg/m³ | 0 | 0 | 30 | 30 |
| Activator, kg/m³ | 0 | 0 | 9.5 | 9.5 |
| Total solids, kg/m³ | 385 | 385 | 309.5 | 309.5 |

### Results

| | | | 30% | 30% | |
|---|---|---|---|---|---|
| | | | cement | cement | % change |
| | Control 1 | Control 2 | reduction | reduction | vs control |
| Sample # | 392 | 390 | 391 | 389 | |
| Water penetration, mm | 13.0 | | 9.67 | | −25.6% |
| Immersed absorption, % | | 5.93 | | 5.23 | −11.8% |
| Boiled absorption, % | | 5.95 | | 5.23 | −12.1% |
| Apparent volume of | | 13.43 | | 11.95 | −11.0% |
| voids, % | | | | | |
| Initial rate of | | 1.91 × 10−3 | | 1.60 × 10⁻³ | −16.2% |
| absorption | | | | | |
| Secondary rate of | | 1.32 × 10⁻³ | | 0.84 × 10⁻³ | −36.4% |
| absorption | | | | | |
| Chloride penetration, | | 0.266 | | 0.224 | −15.8% |
| concentration at depth | | | | | |
| of 8 mm, % w/w | | | | | |
| Surface chloride | | 1.3 | | 1.19 | −8.5% |
| concentration, % w/w | | | | | |
| Transport coefficient, | | 15.20*10⁻¹² | | 15.45*10⁻¹² | 1.6% |
| Dₑ | | | | | |

### Conclusions

Concrete prepared using an activator of the invention with 30% reduced cement in the mix, and provided
enhanced resistance to water penetration over and above control concrete with no cement reduction
enhanced resistance to chloride penetration over and above control concrete with no cement reduction
reduced volume of voids and immersed and boiled absorption
enhanced sorptivity, i.e. reduced initial and secondary rate of absorption

This demonstrates the ability of the concrete containing the activator to have significantly enhanced durability characteristics at significantly lower cement levels, which is partly explained by the tighter microstructure of concrete as a result of optimal chemical and physical properties of the activator.

### Example 5

Aim—This experiment tested various activators of the invention to exemplify their ability to increase compressive strength in mortar at different time points while maintaining cement content compared to a control with no activator and substantially the same mortar mix design.

Methodology—2 L of mortar was prepared for each mix according to the following procedure:
1. Cement added to water in a mixing vessel and mixed at a slow speed for 30 sec.
2. Sand added over 30 seconds while mixing at slow speed.
3. High speed mixing at 30 seconds then let mortar stand for 1.5 min.
4. Mix at high speed for 1 min.

Mortar was prepared according to the following composition:

| Activator Tested | Control | X1 | X2 | X3 |
|---|---|---|---|---|
| Mix ID | 181m | 175m | 176m | 177m |
| Filter sand | 664 | 654 | 690 | 654 |
| Pro-Blend sand | 543 | 535 | 565 | 535 |
| Cement kg/m3 | 532 | 532 | 532 | 532 |
| Pozzolan 3 (NZ Pumice), kg/m3 | 178 | 178 | 178 | 178 |
| Water, kg/m3 | 320 | 320 | 250 | 320 |
| Activator, kg/m3 | 0 | 21 | 21 | 21 |
| Activator, % | 0 | 2 | 3 | 2 |
| Cement reduction % | 25% | 25% | 25% | 25% |
| Cement substitution, % to Control | 25% | 25% | 25% | 25% |

Three different activators were used—X1, X2 and X3. The mixes contained 25% less cement than standard concrete mixtures demand and this was replaced with natural pozzolan (NZ pumice).

The activators had the following particle sizes and chemical compositions:

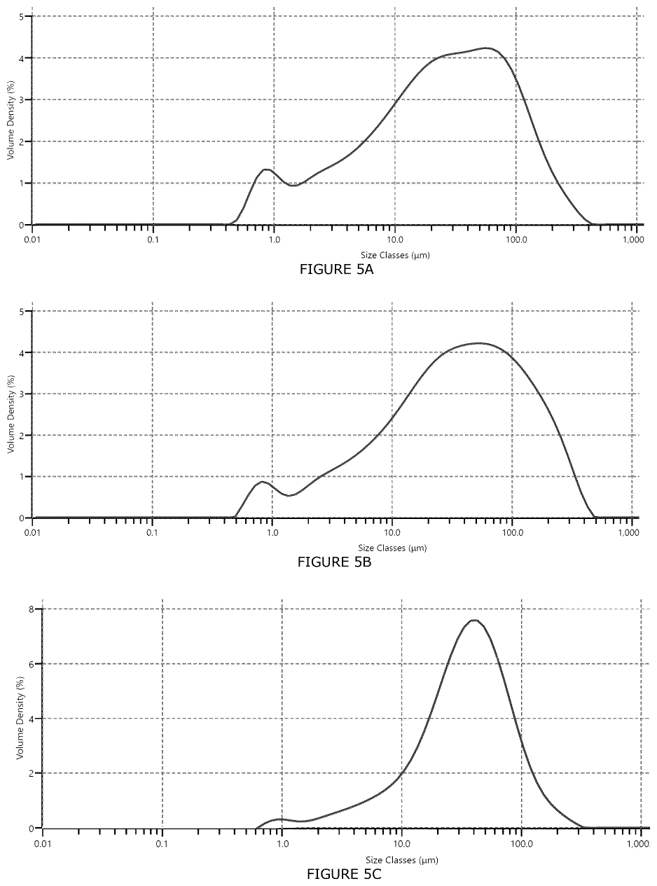

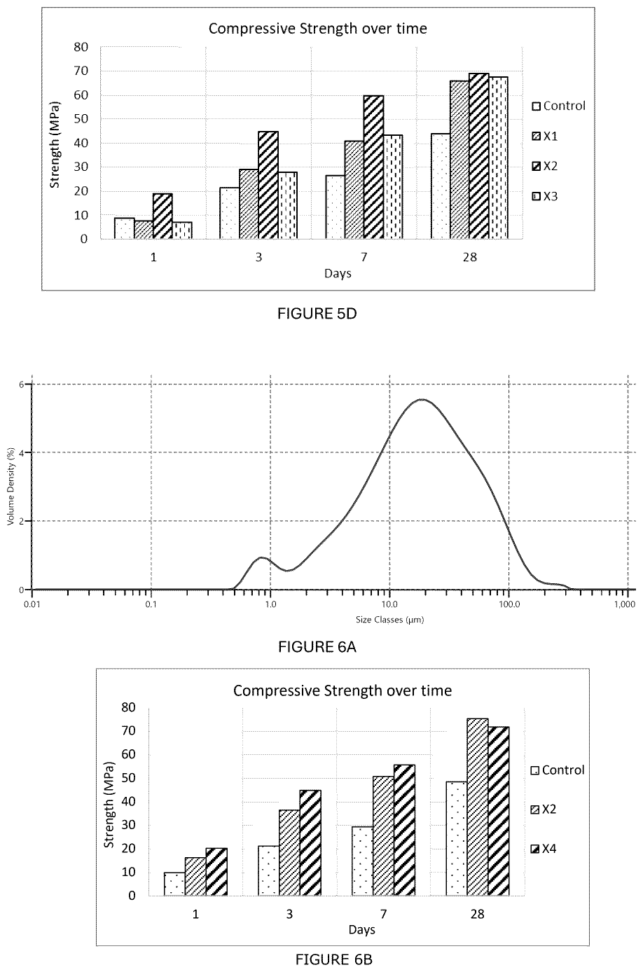

For Activator X1 the particle size distribution is shown in FIG. 5A and the table below:

| | % |
|---|---|
| Size | Volume |
| (μm) | Under |
| 0.05 | 0 |
| 0.06 | 0 |
| 0.12 | 0 |
| 0.24 | 0 |
| 0.49 | 0.04 |
| 0.98 | 4.14 |
| 2 | 8.93 |
| 3.9 | 14.88 |
| 7.8 | 23.94 |
| 15.6 | 37.83 |
| 31 | 55.5 |
| 37 | 60.26 |
| 44 | 64.96 |
| 53 | 70.08 |
| 63 | 74.86 |
| 74 | 79.25 |
| 88 | 83.76 |
| 105 | 87.9 |
| 125 | 91.42 |
| 149 | 94.2 |
| 177 | 96.28 |
| 210 | 97.81 |
| 250 | 98.86 |
| 300 | 99.57 |
| 350 | 99.9 |
| 420 | 100 |
| 500 | 100 |
| 590 | 100 |
| 710 | 100 |
| 840 | 100 |
| 1000 | 100 |
| 1190 | 100 |

For Activator X2 the particle size distribution is shown in FIG. 5B and the table below:

| | % |
|---|---|
| Size | Volume |
| (μm) | Under |
| 0.05 | 0 |
| 0.06 | 0 |
| 0.12 | 0 |
| 0.24 | 0 |
| 0.49 | 0 |
| 0.98 | 2.73 |
| 2 | 5.62 |
| 3.9 | 10.24 |
| 7.8 | 17.62 |
| 10 | 21.21 |
| 15.6 | 29.36 |
| 31 | 46.02 |
| 37 | 50.79 |
| 44 | 55.52 |
| 53 | 60.64 |
| 63 | 65.4 |
| 74 | 69.79 |
| 88 | 74.41 |
| 105 | 78.92 |
| 125 | 83.13 |
| 149 | 87.02 |
| 177 | 90.47 |
| 210 | 93.51 |
| 250 | 96.05 |
| 300 | 98.09 |
| 350 | 99.25 |
| 420 | 99.87 |
| 500 | 100 |
| 590 | 100 |
| 710 | 100 |
| 840 | 100 |
| 1000 | 100 |

For Activator X3 the particle size distribution is shown in FIG. 5C and the table below:

| | % |
|---|---|
| Size | Volume |
| (μm) | Under |
| 0.05 | 0 |
| 0.06 | 0 |
| 0.12 | 0 |
| 0.24 | 0 |
| 0.49 | 0 |
| 0.98 | 0.61 |
| 2 | 1.85 |
| 3.9 | 4.25 |
| 7.8 | 9.16 |
| 10 | 11.91 |
| 15.6 | 19.72 |
| 31 | 43.96 |
| 37 | 52.51 |
| 44 | 61.09 |
| 53 | 70.03 |
| 63 | 77.53 |
| 74 | 83.56 |
| 88 | 88.77 |
| 105 | 92.67 |
| 125 | 95.44 |
| 149 | 97.26 |
| 177 | 98.45 |
| 210 | 99.25 |
| 250 | 99.73 |
| 300 | 99.97 |
| 350 | 100 |
| 420 | 100 |
| 500 | 100 |
| 590 | 100 |
| 710 | 100 |
| 840 | 100 |
| 1000 | 100 |

Activator Particle characteristics:

| Activator Tested | X1 | X2 | X3 |
|---|---|---|---|
| Specific Surface Area | 936.0 | 677.3 | 383.2 |
| Dv (50) | 25.2 | 35.9 | 35.2 |
| Dv (90) | 116 | 173 | 92.6 |
| Particle size % <15 μm | 36.8 | 28.5 | 18.9 |
| Particle size % <40 μm | 62.3 | 52.8 | 56.2 |
| Particle size % <90 μm | 84.2 | 74.9 | 89.2 |
| Chem composition wt %- SiO2 | 24.67 | 36.51 | 74.7 |
| Chem composition wt % - Al2O3 | 5.99 | 8.71 | 13.4 |

### Predictive Method for Estimating 28—Day Compressive Strength

To estimate the 28-day compressive strength of concrete samples where direct measurements were unavailable, a predictive modeling approach was employed. This method leverages the strength development trends observed in other samples to provide accurate predictions.

Data Input—The available compressive strength data for the concrete samples was recorded at 1, 3, and 7 days. The 28-day strength was missing for three samples denoted as X2, X4, and X5.

Model Selection—A logarithmic growth model was chosen to represent the relationship between compressive strength and time. The chosen model reflects the common understanding that the rate of strength gain in concrete decreases over time. The equation used for the prediction was as follows:

Strength=a×ln(day+b)+c where:
Strength is the compressive strength of the concrete at a given day,
day is the time in days,
a, b, and c are parameters to be determined from the data.

Curve Fitting—For each of the samples, the above model was fitted to the known data points (1-day, 3-day, and 7-day strengths). The fitting process was carried out using non-linear regression to optimize the parameters a, b, and c such that the model best matched the observed data.

Prediction—Once the model parameters were determined, the model was used to extrapolate the compressive strength at 28 days. These predicted values were derived based on the logarithmic trend of strength gain observed in the earlier days and are consistent with the expected behaviour of concrete strength development over time.

### Results

Concrete properties are provided in FIG. 5D and in the table below.

| Activator Tested | Control | X1 | X2 | X3 |
|---|---|---|---|---|
| Slump - 0 mins, mm | 210 | 175 | 175 | 170 |
| Slump - 30 mins, mm | 125 | x | x | x |
| Slump - 60 mins, mm | x | x | x | x |
| Strength day 1, MPa | 9 | 8 | 19 | 7 |
| Strength day 3, MPa | 21 | 29 | 45 | 28 |
| Strength day 7, MPa | 27 | 41 | 60 | 43 |
| Strength day 28, MPa | 44 | 66 | 69* | 68 |

*28-day data is predicted based on the model outlined and in accordance with samples with substantially identical 1, 3 and 7 day results.

### Conclusions

All activators of the invention provide increased compressive strength at days 3, 7 and 28 compared to control while maintaining workability (slump).

Activator X2 exhibits significantly higher early strength (days 1, 3 and 7) compared to X1 and X3.

### Example 6

Aim—This experiment tested various activators of the invention to exemplify their ability to increase compressive strength in mortar at different time points while maintaining cement content compared to a control with no activator and substantially the same mortar mix design.

Methodology—2 L of mortar was prepared for each mix according to the following procedure:
1. Cement added to water in a mixing vessel and mixed at a slow speed for 30 sec.
2. Sand added over 30 seconds while mixing at slow speed.
3. High speed mixing at 30 seconds then let mortar stand for 1.5 min.
4. Mix at high speed for 1 min.

Mortar was prepared according to the following composition:

| Activator Tested | Control | X2 | X4 |
|---|---|---|---|
| Mix ID | 182m | 243m | 246m |
| Filter sand | 821 | 803 | 803 |
| Pro-Blend sand | 672 | 657 | 657 |
| Cement kg/m3 | 500 | 500 | 500 |
| Water, kg/m3 | 295 | 225 | 225 |
| Activator, kg/m3 | 0 | 15 | 15 |
| Activator, % | 0 | 3 | 3 |

Two different activators were used - X2 and X4.

The activators had the following particle sizes and chemical compositions:

For Activator X2 the particle size distribution is shown in FIG. 5B and the table in Example 5

For Activator X4 the particle size distribution is shown in FIG. 6A and the table below:

| | % |
|---|---|
| Size | Volume |
| (μm) | Under |
| 0.05 | 0 |
| 0.06 | 0 |
| 0.12 | 0 |
| 0.24 | 0 |
| 0.49 | 0 |
| 0.98 | 2.75 |
| 2 | 5.81 |
| 3.9 | 11.98 |
| 7.8 | 24.49 |
| 10 | 31.14 |
| 15.6 | 45.77 |
| 31 | 69.86 |
| 37 | 75.24 |
| 44 | 80.08 |
| 53 | 84.81 |
| 63 | 88.71 |
| 74 | 91.9 |
| 88 | 94.71 |
| 105 | 96.82 |
| 125 | 98.24 |
| 149 | 99.02 |
| 177 | 99.42 |
| 210 | 99.64 |
| 250 | 99.81 |
| 300 | 99.97 |
| 350 | 100 |
| 420 | 100 |
| 500 | 100 |
| 590 | 100 |
| 710 | 100 |
| 840 | 100 |
| 1000 | 100 |

Activator Particle characteristics:

| Activator Tested | X2 | X4 |
|---|---|---|
| Specific Surface Area m²/kg | 677.3 | 831.0 |
| Dv (50) μm | 35.9 | 17.5 |
| Dv (90) μm | 173 | 66.9 |
| Particle size % <15 μm | 28.5 | 44.2 |
| Particle size % <40 μm | 52.8 | 77.3 |
| Particle size % <90 μm | 74.9 | 95.0 |
| Chem composition wt %- SiO2 | 36.51 | 36.52 |
| Chem composition wt % - Al2O3 | 8.71 | 8.033 |

Where 28 day data was not yet available, the predictive model in example 5 was used to predict it.

### Results

Concrete properties are provided in FIG. 6B and in the table below.

| Activator Tested | Control | X2 | X4 |
|---|---|---|---|
| Slump - 0 mins, mm | 170 | 170 | 165 |
| Slump - 30 mins, mm | x | x | x |
| Strength day 1, MPa | 10 | 16 | 20 |
| Strength day 3, MPa | 21 | 36 | 45 |
| Strength day 7, MPa | 29 | 51 | 56 |
| Strength day 28, MPa | 48 | 75* | 72* |

*28-day data is predicted based on the predictive model outlined for example 5.

Conclusions—All activators of the invention provide increased compressive strength at days 3, 7 and 28 compared to control while maintaining workability (slump).

### Example 7

Aim—This experiment tested activators of the invention to exemplify their ability to maintain or increase compressive strength in mortar at different time points with reduced cement.

Methodology—2 L of mortar was prepared for each mix according to the following procedure:
1. Cement added to water in a mixing vessel and mixed at a slow speed for 30 sec.
2. Sand added over 30 seconds while mixing at slow speed.
3. High speed mixing at 30 seconds then let mortar stand for 1.5 min.
4. Mix at high speed for 1 min.

Mortar was prepared according to the following composition:

| Activator tested | Control | X4-A | X4-B |
|---|---|---|---|
| Filter sand | 821 | 821 | 821 |
| Pro-Blend sand | 672 | 672 | 707 |
| Cement kg/m3 | 500 | 500 | 450 |
| Water, kg/m3 | 295 | 200 | 245 |
| Activator, kg/m3 | | 15 | 15 |
| Activator, % | | 3.00 | 3.33 |
| Cement reduction to Control, % | | | 10% |
| Plasticiser in activator | | Napthalene | Napthalene |

Activator X4 was used which had the particle size characteristics and chemical composition as described in Example 6.

### Results

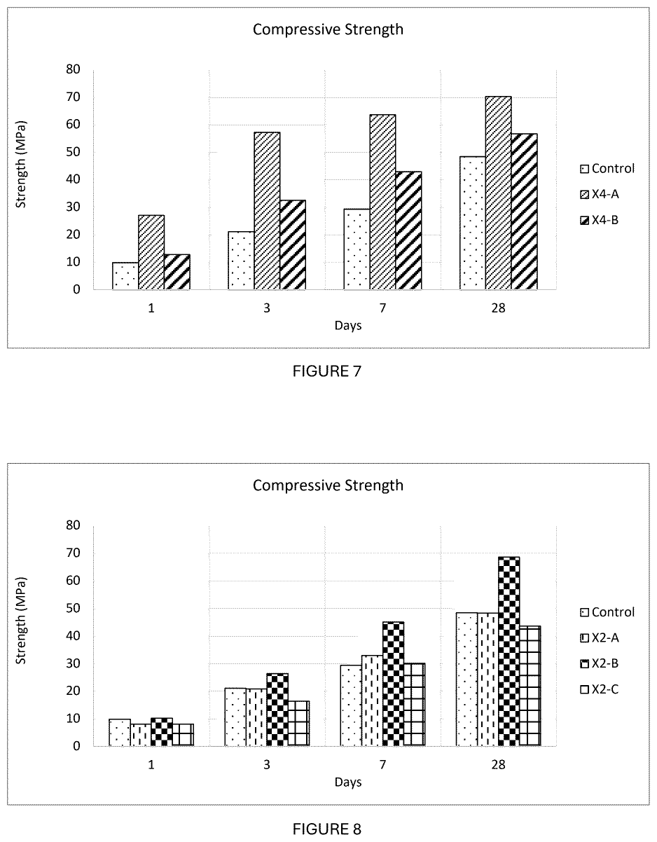

Concrete properties are provided in FIG. 7 and in the table below.

| Activator Tested | Control | X4 | X4 |
|---|---|---|---|
| Flow - 0 mins, mm | 170 | 165 | 150 |
| Flow - 30 mins, mm | x | x | x |
| Strength day 1, MPa | 9.8 | 27.0 | 12.8 |
| Strength day 3, MPa | 21.1 | 57.2 | 32.5 |
| Strength day 7, MPa | 29.3 | 63.6 | 42.9 |
| Strength day 28, MPa | 48.4 | 70.2 | 56.7 |

### Conclusions

The activator of the invention increased compressive strength at days 1, 3, 7 and 28 compared to control while maintaining workability (slump). Cement reduction of 10% was achieved while maintaining increased compressive strength compared to control.

### Example 8

Aim—This experiment tested activators of the invention to exemplify their ability to maintain or increase compressive strength in mortar containing fly ash at different time points with reduced cement.

Methodology—2 L of mortar was prepared for each mix according to the following procedure:
1. Cement added to water in a mixing vessel and mixed at a slow speed for 30 sec.
2. Sand added over 30 seconds while mixing at slow speed.
3. High speed mixing at 30 seconds then let mortar stand for 1.5 min.
4. Mix at high speed for 1 min.

Mortar was prepared according to the following composition:

| Activator tested | Control | X2-A | X2-B | X2-C |
|---|---|---|---|---|
| Pozzolan tested | | Fly Ash | Fly Ash | Fly Ash |
| Filter sand | 821 | 927 | 770 | 750 |
| Pro-Blend sand | 672 | 758 | 630 | 614 |
| Cement kg/m3 | 500 | 350 | 350 | 350 |
| Fly Ash, kg/m3 | | 60 | 225 | 300 |
| Water, kg/m3 | 295 | 225.5 | 280 | 350 |
| Activator, kg/m3 | | 15 | 15 | 15 |
| Activator, % | | 3.66 | 2.61 | 2.31 |
| Cement reduction to Control, % | | 30% | 30% | 30% |
| Cement substitution, % to Control | | 12% | 45% | 60% |
| Plasticiser in activator | | Napthalene | Napthalene | Napthalene |

Activator X2 was used. The X2 activator had the particle size characteristics and chemical composition as described in Example 5.

Results—Concrete properties are provided in FIG. 8 and in the table below.

| Activator Tested | Control | X2-A | X2-B | X2-C |
|---|---|---|---|---|
| Flow - 0 mins, mm | 170 | 175 | 165 | 200 |
| Flow - 30 mins, mm | x | 155 | 155 | x |
| Strength day 1, MPa | 9.8 | 8.0 | 10.1 | 8.0 |
| Strength day 3, MPa | 21.1 | 20.8 | 26.3 | 16.3 |
| Strength day 7, MPa | 29.3 | 32.9 | 45.1 | 30.1 |
| Strength day 28, MPa | 48.4 | 48.3* | 68.5* | 43.6* |

*These values were predicted based on the model described in relation to example 5.

Conclusions—The experiment using activator X2 exhibits higher strength in the 45% substitution versus the 12% fly ash sample and control due to the higher amount of pozzolanic material able to be activated by the activator. For the high (60%) fly ash substitution, there is a higher water demand to maintain workability. At this high substitution, the excess water required results in a reduction in compressive strength as compared to the lower substation (but is still higher than control). Without activator, the high water demand prevents the fly ash from being usable as a substitute. The activator-containing concrete enables the use of high substitution levels of fly ash without negatively affecting the workability.

The activator of the invention maintained or increased compressive strength at days 1, 3, 7 and 28 compared to control while maintaining workability (slump). Cement reduction of 30% was achieved with addition of varying amounts of fly ash at activator percentage between 2.3 and 3.7.

### Example 9—Surface Activation via electrolysis

Aim—This experiment tests the ability and extent of a pozzolan-containing activator, which is subjected to an electrical charge, to activate pozzolanic supplementary cementitious materials (SCMs) to function as a cement binder. The objective is to replace cement with SCMs without detrimental impacts on strength and workability.

Methodology-Six concrete mixes are prepared:
1. Control mix 1:25 MPa grade concrete. The coarse and fine aggregates are prepared according to a proprietary composition by a third party. The amount of these components do not vary across the three treatments proposed herein, but can vary when used in situ for concrete production. A skilled person in the art would be able to readily determine suitable aggregate components and mass required. A powdered polycarboxylate plasticiser is used.
2. Control mix 2:25 MPa grade concrete, with 30% of cement replaced by synthetic pozzolanic SCMs (Slag). The coarse and fine aggregates are provided in the same proportions as in mix 1. A powdered polycarboxylate plasticiser is used.
3. Activator mix 3 (X0): 25 MPa grade concrete, with 30% of cement replaced by synthetic pozzolanic SCMs (Slag) and a standard (non-electro-activated) activator added at 3% of cementitious material. The coarse and fine aggregates are provided in the same proportions as in mix 1. A powdered polycarboxylate plasticiser is used.
4. Electro-activated mix 4 (XV1): 25 MPa grade concrete, with 30% of cement replaced by natural pozzolans (NZ pumice) with electro-activated activator described below at 3% of cementitious material. The coarse and fine aggregates are provided in the same proportions as in mix 1.
5. Electro-activated mix 5 (XV2): 25 MPa grade concrete, with 30% of cement replaced by synthetic pozzolanic SCMs (Slag) with electro-activated activator described below at 3% of cementitious material. The coarse and fine aggregates are provided in the same proportions as in mix 1.
6. Electro-activated mix 6 (XV3): 25 MPa grade concrete, with 30% of cement replaced by fly ash with electro-activated activator described below at 3% of cementitious material. The coarse and fine aggregates are provided in the same proportions as in mix 1.

Water content for each mix is adjusted to achieve a target slump on mixing of 180 mm (+40 mm permissible tolerance on slump). Sand and aggregates as per control.

The following concrete compositions are mixed:

| Activator tested | Control 1 | Control 2 | X0 | XV1 | XV2 | XV3 |
|---|---|---|---|---|---|---|
| Atlas 19 mm | 620 | 620 | 620 | 620 | 620 | 620 |
| kg/m3 | | | | | | |
| Atlas 10 mm, | 380 | 380 | 380 | 380 | 380 | 380 |
| kg/m3 | | | | | | |
| Atlas Sand | 880 | 870 | 870 | 870 | 870 | 870 |
| Cement kg/m3 | 350 | 245 | 245 | 245 | 245 | 245 |
| NZ Pumice | | | | 105 | | |
| Slag | | 105 | 105 | | 105 | |
| Fly Ash, kg/m3 | | | | | | 105 |
| Water, kg/m3 | 170 | 180 | 145 | 145 | 145 | 145 |
| Water reducer, | 2.8 | 2.8 | | | | |
| l/m3 | | | | | | |
| Activator, kg/m3 | | | 10.5 | 10.5 | 10.5 | 10.5 |
| Activator, % | | | 3 | 3 | 3 | 3 |
| Cement | | 30% | 30% | 30% | 30% | 30% |
| reduction to | | | | | | |
| Control, % | | | | | | |
| Cement | | 30% | 30% | 30% | 30% | 30% |
| substitution, % to | | | | | | |
| Control | | | | | | |
| Plasticiser in | | PCE | PCE | PCE | PCE | PCE |
| activator | | | | | | |

The electro-activated mix contains an activator subject to an electrical charge before formulation with other concrete components. The activator is formulated to have the chemical composition provided for X2 in example 5 above.

### Electro-Activation Process:

A non-conductive container is used to hold the powdered activator. The container is equipped with two electrodes made of an inert material (e.g., graphite or platinum) to prevent any unwanted reactions with the admixture. A direct current (DC) power supply with adjustable voltage and current settings is connected to the electrodes. The powdered activator is evenly spread within the container, ensuring good contact with the electrodes. The depth of the powder should allow for efficient electro-activation while avoiding excessive resistance. The power supply is set to a low voltage (12V) and current (2A). The current is passed through the powdered admixture for a duration of 30 minutes to one hour. This timeframe is sufficient to induce electrical activation. During electro-activation, the powder is gently stirred using a non-conductive stirrer at regular intervals (every 5-10 minutes) to ensure uniform exposure to the electric field. After the activation period, the electrical current is turned off, and the powder is allowed to cool and settle. This step ensures that the entire batch of the activator is uniformly charged and ready for use in concrete mixes.

### Results

Results show that control mix 2 has lower strength compared to the control 1. In accordance with earlier embodiments of the invention, activator X0 exhibits equivalent slump with improved compressive strength versus control 1 and control 2. The electro-activated XV1, XV2 and XV3 concrete shows increased strength at time points 1,3,7 compared to the activator X0 due to the enhanced surface activation leading to higher reactivity with pozzolan replacements.

### Conclusions

Electro-activated activator provides increased early strength due to the enhanced surface activation of the activator particles and increased binding activity with pozzolan SCMs (e.g. synthetic or natural pozzolans).

At higher cement replacement levels, a higher dosage of activator can be used, for example, 3.5% activator for 40% cement replacement levels and 4% activator for 50% cement replacement.

Based on the data, it is expected that a higher cement replacement percentage is possible (e.g., 60% or 70%) while maintaining equal or greater strength compared to cement-containing control samples. This is predictable based on the significant strength surplus observed at each age of strength setting.

The electro-activated activator can activate both natural and synthetic pozzolans to become an effective binder similar to or better in properties than cement.

This example demonstrates the enhanced performance of concrete when using an electro-activated activator, highlighting the potential benefits of applying an electrical charge to the activator prior to inclusion in the concrete mix.

### Example 10

Aim—This experiment tested activators of the invention to exemplify their ability to maintain or increase compressive strength in mortar at different time points with reduced cement.

Methodology—2 L of mortar was prepared for each mix according to the following procedure:
5. Cement added to water in a mixing vessel and mixed at a slow speed for 30 sec.
6. Sand added over 30 seconds while mixing at slow speed.
7. High speed mixing at 30 seconds then let mortar stand for 1.5 min.
8. Mix at high speed for 1 min.

Mortar was prepared according to the following composition:

| | | | | X2-A | X2-B |
|---|---|---|---|---|---|
| | | 25% | 50% | 25% | 50% |
| Activator Tested | Control | redn | redn | redn | redn |
| Filter sand | 685 | 664 | 633 | 690 | 660 |
| Pro-Blend sand | 561 | 543 | 518 | 565 | 540 |
| Cement kg/m3 | 710 | 532 | 355 | 532 | 355 |
| Pozzolan 3 (NZ Pumice), kg/m3 | 0 | 178 | 355 | 178 | 355 |
| Water, kg/m3 | 320 | 320 | 320 | 250 | 255 |
| Activator, kg/m3 | 0 | 0 | 0 | 21 | 21 |
| Activator, % | 0 | 0 | 0 | 3 | 3 |
| Cement reduction to Control, % | 0 | 25 | 50 | 25 | 50 |

Activator X2 was used which had the particle size characteristics and chemical composition as described in Example 5.

### Results

Concrete properties are provided in FIG. 10 and in the table below.

| | | | | X2-A | X2-B |
|---|---|---|---|---|---|
| | | 25% | 50% | 25% | 50% |
| Activator Tested | Control | redn | redn | redn | redn |
| Slump - 0 mins, mm | 220 | 210 | 165 | 200 | 180 |
| Slump - 30 mins, mm | x | x | x | x | x |
| Strength day 1, MPa | 21 | 9 | 8 | 19 | 11 |
| Strength day 3, MPa | 38 | 21 | 15 | 45 | 27 |
| Strength day 7, MPa | 57 | 27 | 21 | 60 | 37 |
| Strength day 28, MPa | 73 | 44 | 31* | 82* | 52* |

### Conclusions

25% and 50% reduction in cement and replacement with natural pozzolan significantly reduced compressive strength at all time points.

When activator was added at 3% of cementitious material, compressive strength for both 25% and 50% pozzolan substituted mixes increased significantly compared to the respective mixes not containing activator X2.

What is claimed is:

1-48. (canceled)

49. An activator admixture for producing concrete, the activator admixture comprising a pozzolan component,
wherein the pozzolan component comprises a first pozzolan portion and at least a second pozzolan portion, wherein the first and second pozzolan portions comprise different median particle sizes and chemical compositions;
wherein the pozzolan component comprises a chemical composition comprising 20-80% w/w silicon dioxide, and 5-40% w/w aluminium oxide; and
wherein the activator admixture further comprises a plasticiser present at between about 8% and 40% w/w of the activator admixture.

50. The activator admixture of claim 49, further comprising a powdered plasticiser component mixed with the pozzolan component.

51. The activator admixture of claim 49, wherein the activator admixture comprises an electrostatic charge.

52. The activator admixture of claim 49, wherein the pozzolan component comprises a bi-modal, tri-modal, or multi-modal particle size distribution.

53. The activator admixture of claim 49, wherein the first pozzolan portion comprises an intermediate median particle size in a range of 0.5-1.5 μm and the second pozzolan portion comprises a coarse median particle size in a range of 10-80 μm.

54. The activator admixture of claim 49, wherein a specific surface area of the activator admixture comprises between 350-1000 m²/kg.

55. The activator admixture of claim 49, wherein a particle size distribution of the activator admixture is defined by: 15-55% of particles are less than 15 μm; 50-80% of particles are less than 40 μm; and 70-100% of particles are less than 90 μm.

56. The activator admixture of claim 49, wherein a ratio between the pozzolan component and the plasticiser comprises from about 11:1 pozzolan: plasticiser to about 1.5:1 pozzolan: plasticiser, and wherein the plasticiser comprises a Dv50 of from 50-500 μm or 100-200 μm.

57. A method of producing an activator admixture composition comprising:
obtaining a first pozzolan portion with a first chemical composition and a first median particle size and a second pozzolan portion with a second chemical composition and a second median particle size;
combining the first pozzolan portion with the second pozzolan portion to form a pozzolan component; and
mixing the pozzolan component with a plasticiser to produce an activator admixture composition,
wherein the pozzolan component comprises a chemical composition comprising 20-80% w/w silicon dioxide, and 5-40% aluminium oxide,
wherein the plasticiser comprises 8-40% w/w of the activator admixture composition, and
wherein the first and second pozzolan portions comprise different median particle sizes.

58. The method of claim 57, wherein the activator admixture comprises an electrostatic charge.

59. The method of claim 58, wherein the electrostatic charge is applied to the activator admixture by way of external electrical fields generated by electrodes, electrostatic spraying techniques, triboelectric charging in a fluidised bed, corona discharge methods, electrostatic fluidisation, and mechanical mixing-induced friction.

60. The method of claim 57, wherein the activator admixture comprises a particle size distribution defined by: 15-55% of particles are less than 15 μm; 50-80% of particles are less than 40 μm; and 70-100% of particles are less than 90 μm.

61. The method of claim 60, further comprising:
identifying a chemical composition of a first pozzolan as the first pozzolan portion;
identifying a chemical composition of a second pozzolan as the second pozzolan portion; and
calculating an amount of the first pozzolan and an amount of the second pozzolan required to achieve the chemical composition of the pozzolan component.

62. A concrete composition comprising:
an activator admixture comprising a pozzolan component, wherein the pozzolan component comprises a first pozzolan portion and at least a second pozzolan portion, wherein the first and second pozzolan portions comprise different median particle sizes and chemical compositions, wherein the pozzolan component comprises a chemical composition comprising 20-80% w/w silicon dioxide, and 5-40% w/w aluminium oxide, and wherein the activator admixture further comprises a plasticiser present at between about 8% and 40% w/w of the activator admixture;
a cementitious material; and
an aggregate.

63. The concrete composition of claim 62, wherein the cementitious material comprises cement and pozzolanic filler, and wherein the filler comprises pozzolanic SCMs and is present in an amount of 10 to 50% w/w of cementitious material.

64. The concrete composition of claim 62, wherein the cementitious material comprises cement at a quantity selected from the group consisting of less than 50%, less than 60%, less than 70%, less than 80% or less than 90% cement.

65. The concrete composition of claim 62, wherein the activator admixture is present in a quantity of 1-4% w/w of the cementitious material.

66. The concrete composition of claim 62, wherein the cementitious material is present at a reduced quantity in the composition compared to a reference quantity of cementitious material in a reference concrete composition, wherein the reduced quantity is defined by a reference quantity reduced by a reduction factor, and wherein the reference concrete composition does not include the activator; wherein the reduction factor is 10% to 50%.
